(19) United States
(12) Patent Application Publication
(10) Pub. No.: US 2023/0132441 A1
(43) Pub. Date: May 4, 2023

(54) EXPENSE MANAGEMENT DEVICE, INFORMATION PROCESSING METHOD, AND RECORDING MEDIUM

(71) Applicant: Miletos Inc., Tokyo (JP)

(72) Inventors: Masaaki HIRANO, Tokyo (JP); Yasufumi TAKAHASHI, Tokyo (JP)

(21) Appl. No.: 17/925,734

(22) PCT Filed: May 17, 2021
(86) PCT No.: PCT/JP2021/018629

§ 371 Date: Nov. 16, 2022

(30) Foreign Application Priority Data
May 19, 2020 (JP) 2020-087173

(51) Int. Cl. G06Q 40/12

(52) U.S. Cl. CPC G06Q 40/12

(57) ABSTRACT

With conventional art, it has been impossible to communicate the results of inspections of expense applications to the applicants. With an expense management device that includes: an expense acceptance unit that accepts expense information that specifies details of an application for an expense; an inspection result acquisition unit that acquires an inspection result that is a result of an inspection of improperness regarding the expense information accepted by the expense acceptance unit; a first judging unit that judges whether or not the inspection result acquired by the inspection result acquisition unit satisfies a predetermined first condition; and a contact processing unit that performs contact processing to provide the inspection result to an applicant of the expense information when the judging unit judges that the first condition is satisfied, it is possible to inform an applicant with an inspection result regarding an inspection of an expense application.

### TECHNICAL FIELD

The present invention relates to an expense management device, etc. for assisting in proper application for expenses.

### BACKGROUND ART

Conventionally, there has been an accounting system capable of checking the objectivity and consistency of transaction data, for example, between companies, between a company and individuals, or socially (see Patent Document 1).

### CITATION LIST

### Patent Document

Patent Document 1: JP2017-97669A

### SUMMARY OF INVENTION

### Technical Problem

However, with the conventional art, it has been impossible to communicate the results of inspections of expense applications to the applicants or the like.

### Solution to Problem

An expense management device according to a first aspect of the present invention is an expense management device including: an expense acceptance unit that accepts expense information that specifies details of an application for an expense; an inspection result acquisition unit that acquires an inspection result that is a result of an inspection of improperness regarding the expense information accepted by the expense acceptance unit; a first judging unit that judges whether or not the inspection result acquired by the inspection result acquisition unit satisfies a predetermined first condition; and a contact processing unit that performs contact processing to provide the inspection result to an applicant of the expense information when the judging unit judges that the first condition is satisfied.

With such a configuration, it is possible to inform the applicant of the inspection result of the expense application.

An expense management device according to a second aspect of the present invention is the expense management device according to the first aspect, wherein the contact processing unit performs accumulation processing to accumulate the inspection result in association with an applicant identifier corresponding to the expense information accepted by the expense acceptance unit.

With such a configuration, it is possible to inform the applicant of the inspection result of the expense application by accumulating the inspection result in a server or the like.

An expense management device according to a third aspect of the present invention is the expense management device according to the second aspect, wherein the contact processing unit performs first transmission processing to acquire a URI that is used to access the inspection result accumulated through the accumulation processing, acquire the applicant identifier corresponding to the expense information accepted by the expense acceptance unit, acquire an e-mail address that is paired with the applicant identifier, from a personal information storage unit that stores one or more pieces of personal information that each include an applicant identifier and an e-mail address, and transmit the URI, using the e-mail address.

With such a configuration, it is possible to inform the applicant of the inspection result of the expense application by notifying the applicant of the URI of the location where the inspection result of the expense application is accumulated.

An expense management device according to a fourth aspect of the present invention is the expense management device according to the second or the third aspect, further including: an e-mail address storage unit that stores an e-mail address of a person in charge of accounting, wherein the contact processing unit performs a second transmission processing to acquire a URI that is used to access the inspection result accumulated through the accumulation processing, and transmit the URI, using the e-mail address of the person in charge of accounting.

With such a configuration, it is also possible to inform the person in charge of accounting of the inspection result of the expense application.

An expense management device according to a fifth aspect of the present invention is the expense management device according to the first aspect, wherein the contact processing unit performs third transmission processing to acquire the applicant identifier corresponding to the expense information accepted by the expense acceptance unit, acquire an e-mail address that is paired with the applicant identifier, from a personal information storage unit that stores one or more pieces of personal information that each include an applicant identifier and an e-mail address, and transmit the inspection result, using the e-mail address.

With such a configuration, it is possible to inform the applicant of the inspection result of the expense application by e-mail.

An expense management device according to a sixth aspect of the present invention is the expense management device according to the fifth aspect, further including: an e-mail address storage unit that stores an e-mail address of a person in charge of accounting, wherein the contact processing unit performs fourth transmission processing to transmit the inspection result, using the e-mail address of the person in charge of accounting.

With such a configuration, it is possible to inform the person in charge of accounting of the inspection result of the expense application by e-mail.

An expense management device according to a seventh aspect of the present invention is the expense management device according to any one of the first to the fifth aspect, further including: a response receiving unit that receives response information regarding a response to the inspection result from an applicant terminal, in association with an applicant identifier; and a response accumulation unit that accumulates the response information received by the response receiving unit, in association with the inspection result.

With such a configuration, it is possible to accept and manage a response regarding the expense application.

An expense management device according to an eight aspect of the present invention is the expense management device according to the seventh aspect, further including: a second judging unit that judges whether or not the response information satisfies a predetermined second condition; and a post-processing unit that, when the second judging unit judges that the second condition is satisfied, performs post-processing after a response is made to the inspection result.

With such a configuration, it is possible to perform appropriate processing corresponding to the accepted response.

An expense management device according to a ninth aspect of the present invention is the expense management device according to the seventh or the eighth aspect, further including: a response deadline storage unit that stores a response deadline; a third judging unit that judges whether or not the response receiving unit has received the response information by the response deadline; and a no-response processing unit that performs predetermined no-response processing for the case of the absence of a response when the third judging unit judges that the response information has not been received by the response deadline.

With such a configuration, it is possible to perform appropriate processing when no response is accepted by the deadline.

An expense management device according to a tenth aspect of the present invention is the expense management device according to any one of the first to the ninth aspect, wherein the inspection result acquisition unit performs an inspection of improperness regarding the expense information accepted by the expense acceptance unit, using external information other than expense information, or expense information other than the expense information accepted by the expense acceptance unit, to acquire an inspection result.

With such a configuration, it is possible to appropriately perform an inspection of an inappropriate expense application, using external information or expense information other than the expense information of the submitted application.

An expense inspection device according to the present invention is an expense inspection device including: an expense acceptance unit that accepts expense information that specifies details of an application for an expense; an inspection unit that inspects improperness regarding the expense information accepted by the expense acceptance unit, using external information other than expense information, or expense information other than the expense information accepted by the expense acceptance unit, to acquire an inspection result; and a result output unit that outputs the inspection result acquired by the inspection unit.

With such a configuration, it is possible to appropriately perform an inspection of an inappropriate expense application, using external information or expense information other than the expense information of the submitted application.

An expense inspection device according to the present invention is the above-described expense inspection device, wherein the expense acceptance unit accepts expense information in association with an applicant identifier that identifies an applicant of an expense, the external information is information corresponding to two or more applicants, and include an applicant group that includes two or more pieces of applicant information associated with applicant identifiers, and the inspection unit acquires applicant information associated with an applicant identifier associated with the expense information accepted by the expense acceptance unit, from the applicant group, and performs an inspection of improperness regarding the expense information accepted by the expense acceptance unit, using the applicant information, to acquire an inspection result.

With such a configuration, it is possible to appropriately perform an inspection of an inappropriate expense application, using applicant information.

An expense inspection device according to the present invention is the above-described expense inspection device, wherein the expense information includes usage date information that specifies a date when the expense was spent, the applicant information includes one or more pieces of attendance information that each include working day information that specifies days on which the applicant identified by the applicant identifier worked, and the inspection unit performs an inspection of improperness regarding the expense information accepted by the expense acceptance unit, using attendance information that is associated with the applicant identifier associated with the expense information and that includes working day information that is the same as the usage date information, to acquire an inspection result.

With such a configuration, it is possible to appropriately perform an inspection of an inappropriate expense application, using the attendance information of the applicant.

An expense inspection device according to the present invention is the above-described expense inspection device, wherein the expense information includes usage date information that specifies a date when the expense was spent, the applicant information includes one or more pieces of entry/exit information that each specify date and time when the applicant identified by the applicant identifier entered/exited a place of work thereof, and the inspection unit performs an inspection of improperness regarding the expense information accepted by the expense acceptance unit, using entry/exit information that is associated with the applicant identifier associated with the expense information, and that corresponds to a day specified by the usage date information included in the expense information, to acquire an inspection result.

With such a configuration, it is possible to appropriately perform an inspection of an inappropriate expense application, using the entry/exit information of the applicant.

An expense inspection device according to the present invention is the above-described expense inspection device, wherein the expense information includes usage date information that specifies a date when the expense was spent, the applicant information includes business activity information that includes business day information that specifies days on which the applicant performed business activities and one or more location identifiers that each specify a visited location, and the inspection unit performs an inspection of improperness regarding the expense information accepted by the expense acceptance unit, using one or more location identifiers included in business activity information that is associated with the applicant identifier associated with the expense information accepted by the expense acceptance unit, and that includes business day information that is the same as the usage date information included in the expense information, to acquire an inspection result.

With such a configuration, it is possible to appropriately perform an inspection of an inappropriate expense application, using the business activity information of the applicant.

An expense inspection device according to the present invention is the above-described expense inspection device, wherein the expense information includes usage date information that specifies a date when the expense was spent, the applicant information includes credit card statement information that is information that indicates a statement of a credit card used by the applicant, and includes usage date information on which the credit card was used, and the inspection unit performs an inspection of improperness regarding the expense information accepted by the expense acceptance unit, using credit card statement information that is associated with the applicant identifier associated with the expense information accepted by the expense acceptance unit, and that includes usage date information that is the same as the usage date information included in the expense information, to acquire an inspection result.

With such a configuration, it is possible to appropriately perform an inspection of an inappropriate expense application, using the credit card statement information of the applicant.

An expense inspection device according to the present invention is the above-described expense inspection device, wherein the expense information includes usage date information that specifies a date when the expense was spent, the applicant information includes one or more pieces of business vehicle location information that each specify a location of a business vehicle used by the applicant and that each are associated with usage date information that specifies a day on which the business vehicle was used, and the inspection unit acquires one or more pieces of business vehicle location information that are associated with the applicant identifier associated with the expense information accepted by the expense acceptance unit and are associated with usage date information that is the same as the usage date information included in the expense information, and performs an inspection of improperness regarding the expense information, using the business vehicle location information, to acquires an inspection result.

With such a configuration, it is possible to appropriately perform an inspection of an inappropriate expense application, using the business vehicle location information of the applicant.

An expense inspection device according to the present invention is the above-described expense inspection device, the expense information is associated with an expense type identifier that indicates an expense type, the applicant information includes owned card information regarding a card owned by the applicant, the expense inspection device further includes a credit card usage expense storage unit that stores one or more expense type identifiers of expenses scheduled to be paid by credit card, and the inspection unit inspects whether or not an expense type identifier that is associated with the expense information accepted by the expense acceptance unit is stored in the credit card usage expense storage unit as an expense type identifier corresponding to the owned card information associated with the applicant identifier associated with the expense information accepted by the expense acceptance unit, to acquire an inspection result.

With such a configuration, it is possible to appropriately perform an inspection of an inappropriate expense application, using information regarding a credit card owned by the applicant.

An expense inspection device according to the present invention is the above-described expense inspection device, wherein the external information includes company regulation information regarding regulations of a company to which the applicant belongs, and the inspection unit performs an inspection to judge whether or not the expense information accepted by the expense acceptance unit meets the company regulations, using the company regulation information, to acquire an inspection result.

With such a configuration, it is possible to appropriately perform an inspection of an inappropriate expense application, using company regulation information.

An expense inspection device according to the present invention is the above-described expense inspection device, the expense information includes usage date information that specifies a day on which an expense was spent, and transportation expense information that includes one or more pieces of section information that each include a departure identifier, an arrival identifier, and fare information, the external information includes transportation means information that includes calculation information that is used to calculate a transportation expense, and the inspection unit performs an inspection of improperness regarding transportation expense, using the expense information accepted by the expense acceptance unit and the transportation means information, to acquire an inspection result.

With such a configuration, it is possible to appropriately perform an inspection of an inappropriate expense application, using transportation means information.

An expense inspection device according to the present invention is the above-described expense inspection device, the external information includes a store group that is constituted by one or more pieces of store information that each include a store identifier that identifies a store, the expense information includes a store identifier that identifies a store where the expense was spent, and the inspection unit performs an inspection of improperness regarding the expense information, using a store identifier that is included in the expense information accepted by the expense acceptance unit and store information that is included in the store group, to acquire an inspection result.

With such a configuration, it is possible to appropriately perform an inspection of an inappropriate expense application, using a store group.

An expense inspection device according to the present invention is the above-described expense inspection device, wherein the store information includes amount information, the expense information includes spent-amount information that specifies the amount of money spent, and the inspection unit performs an inspection of improperness regarding the expense information, using amount information that is paired with a store identifier that is included in the expense information accepted by the expense acceptance unit and the spent-amount information included in the expense information, to acquire an inspection result.

With such a configuration, it is possible to appropriately detect an improper spending at a store.

An expense inspection device according to the present invention is the above-described expense inspection device, the expense information includes a counterparty identifier that specifies a counterparty for which an expense was spent, the external information includes one or more pieces of counterparty information regarding candidates of counterparties for which the expense can be used, and the inspection unit inspects improperness regarding expense information, using a counterparty identifier that is included in the expense information accepted by the expense acceptance unit and one or more pieces of counterparty information that are included in the external information, to acquire an inspection result.

With such a configuration, it is possible to appropriately detect an improper spending for an inappropriate counterparty.

An expense inspection device according to the present invention is the above-described expense inspection device, the expense information includes an expense type identifier that indicates a business trip expense, and usage date information, the external information includes one or more of; one or more pieces of attendance information that each include working day information; and one or more pieces of entry/exit information that each specify date and time of entry/exit, and the inspection unit acquires attendance information or entry/exit information that is associated with an applicant identifier and usage date information that are associated with the expense information accepted by the expense acceptance unit, and performs an inspection of improperness regarding a business travel expense, using the attendance information or the entry/exit information, to acquire an inspection result.

With such a configuration, it is possible to appropriately detect an inappropriate business travel expense.

An expense inspection device according to the present invention is the above-described expense inspection device, the expense information includes usage date information that specifies a day on which an expense was spent, and transportation expense information that includes one or more pieces of section information that each include a departure identifier, an arrival identifier, and fare information, the external information includes transportation means information that includes calculation information that is used to calculate a transportation expense, or an applicant group that includes one or more pieces of applicant information, each piece of applicant information includes commuter pass section information that specifies a commuter pass section of the applicant, or business activity information that includes business day information that specifies days on which the applicant performed business activities, and one or more location identifiers that each specify a visited location, and the inspection unit acquires applicant information associated with the applicant identifier associated with the expense information regarding a transportation expense accepted by the expense acceptance unit, and performs an inspection of improperness regarding an application for the transportation expense, using the applicant information, or the applicant information and the transportation means information, to acquire an inspection result.

With such a configuration, it is possible to appropriately detect an inappropriate transportation expense.

An expense inspection device according to the present invention is the above-described expense inspection device, wherein the inspection unit judges whether or not the expense information accepted by the expense acceptance unit and one or more pieces of expense information in the past stored in the expense information storage unit in association with the applicant identifier that is the same as the applicant identifier associated with the expense information are similar enough to satisfy a predetermined condition, to acquire an inspection result.

With such a configuration, it is possible to appropriately detect duplicate applications, reuse of a receipt, and so on.

An expense inspection device according to the present invention is the above-described expense inspection device, wherein the expense information includes usage date information that specifies a date of stay at an accommodation facility, the applicant information includes attendance information that includes one or more sets each consisting of one or more pieces of working day information that each specify a day on which an applicant corresponding thereto worked and working time information that specifies a time zone for which the applicant worked, or one or more pieces of entry/exit information that each specify date and time at which the applicant entered/exited a place of work thereof, the external information includes company regulation information that includes overtime work time information that specifies a time from which an overnight stay is permitted, and the inspection unit acquires a work end time that is included in working day information or entry/exit information that is associated with the applicant identifier associated with the expense information, and that is paired with working day information that is the same as usage date information that is included in the expense information, and judges whether or not an overnight stay at an accommodation facility is permitted, using the working time information or the work end time and the overtime time work time information, to acquire an inspection result.

With such a configuration, it is possible to appropriately detect an improper application for an accommodation expense.

An expense inspection device according to the present invention is the above-described expense inspection device, wherein the expense information includes usage date information that is associated with an applicant identifier and that specifies a date when the expense was spent, and includes a store identifier that identifies a store on which the expense was used, and the inspection unit inspects two or more pieces of expense information that are associated with one applicant identifier and judges whether or not the number of pieces of expense information that include the same usage date information is large enough to satisfy a predetermined condition, to acquire an inspection result.

With such a configuration, it is possible to appropriately detect an improper application for an after-party expense.

An expense inspection device according to the present invention is the above-described expense inspection device, further including: a statistical processing unit that performs statistical processing based on two or more pieces of expense information that are stored in an expense information storage unit that stores two or more pieces of expense information that are associated with the applicant identifier, to acquire a statistical processing result, and the inspection unit performs an inspection regarding whether or not the statistical processing result satisfies a predetermined condition, to acquire an inspection result.

With such a configuration, it is possible to appropriately perform an inspection of an inappropriate expense application, using a statistical processing result that is based on two or more pieces of expense information.

An expense inspection device according to the present invention is the above-described expense inspection device, wherein the expense information includes a store identifier that identifies a store where the expense was spent, the statistical processing unit acquires store frequency information regarding a frequency of use of a store identified by a store identifier, using the store identifier included in the two or more pieces of expense information that are stored in the expense information storage unit and are associated with one applicant identifier, and the inspection unit performs an inspection regarding whether or not the store frequency information acquired by the statistical processing unit satisfies a predetermined condition, to acquire an inspection result.

With such a configuration, it is possible to detect that a specific store is used frequently.

An expense inspection device according to the present invention is the above-described expense inspection device, wherein the expense information includes a counterparty identifier that identifies a counterparty for which the expense was spent, the statistical processing unit acquires entertainment frequency information regarding a frequency of spending for a counterparty identified by a counterparty identifier, using the counterparty identifier included in two or more pieces of expense information that are stored in the expense information storage unit and are associated with one applicant identifier, and the inspection unit performs an inspection regarding whether or not entertainment frequency information acquired by the statistical processing unit satisfies a predetermined condition, to acquire an inspection result.

With such a configuration, it is possible to detect that an expense is frequently spent for a specific counterparty.

An expense inspection device according to the present invention is the above-described expense inspection device, wherein the statistical processing unit acquires an improper application count that is the number of times an inspection result that is a result of the inspection of expense information corresponding to one applicant identifier and that corresponds to an improper application has been acquired, in association with one applicant identifier, and the inspection unit performs an inspection regarding whether or not the improper application count acquired by the statistical processing unit satisfies a predetermined condition, to acquire an inspection result.

With such a configuration, it is possible to detect that a specific person has submitted an improper application frequently.

An expense inspection device according to the present invention is the above-described expense inspection device, wherein the company regulation information includes approver information that specifies that a person can be an approver of an expense, the expense information includes an approver identifier that identifies an approver of the expense, and the inspection unit performs an inspection to judge whether or not the approver identified by the approver identifier is the approver specified by the approver information, to acquire an inspection result.

With such a configuration, it is possible to detect that the approver of an expense application does not satisfy requirements.

An expense inspection device according to the present invention is the above-described expense inspection device, wherein the applicant information includes at least one of one or more pieces of attendance information that each include working day information that specifies days on which the applicant identified by the applicant identifier worked; one or more pieces of entry/exit information that each specify date and time when the applicant identified by the applicant identifier entered/exited a place of work thereof; one or more pieces of business activity information that each include business day information that specifies days on which the applicant performed business activities and one or more location identifiers that each specify a visited location; and one or more pieces of business vehicle location information that each specify a location of a business vehicle used by the applicant and that each are associated with usage date information that specifies a day on which the business vehicle was used, and the inspection unit judges whether or not the expense information corresponding to the applicant information is present in the expense information storage unit in which one or more pieces of expense information associated with one applicant identifier are stored, using the applicant information corresponding to one applicant identifier, to perform an application omission inspection regarding whether or not an expense application corresponding to the applicant information has been performed, and acquires an inspection result.

With such a configuration, it is possible to detect an omission of an expense application.

An expense inspection device according to the present invention is the above-described expense inspection device, wherein the expense information includes a receipt image, the inspection unit includes an image inspection part that inspects a receipt image to acquire an image inspection result, and the result output unit outputs the image inspection result.

With such a configuration, it is possible to appropriately inspect a receipt image.

An expense inspection device according to the present invention is the above-described expense inspection device, wherein the image inspection part acquires one or more strings from the receipt image, and judges whether or not the one or more strings satisfy a predetermined condition, to acquire an image inspection result.

With such a configuration, it is possible to appropriately inspect descriptions on a receipt image.

An expense inspection device according to the present invention is the above-described expense inspection device, wherein the receipt image includes a time stamp, and the image inspection part acquires the time stamp included in the receipt image, acquires a receipt issuance date corresponding to the receipt image, and judges whether or not a date indicated by the time stamp is later than the receipt issuance date by a predetermined period or longer, to acquire an image inspection result.

With such a configuration, it is possible to perform an inspection of a flawed time stamp on a receipt image.

An expense inspection device according to the present invention is the above-described expense inspection device, wherein the image inspection part performs at least either first unclearness processing or second unclearness processing to acquire an image inspection result, the first unclearness processing being processing through which, using a character recognition technology, the image inspection part acquires one or more strings from the receipt image accepted by the expense acceptance unit, together with a character recognition score, and judges that the receipt image is unclear if the score is low enough to satisfy a predetermined condition, and the second unclearness processing being processing through which, using a learner and the receipt image accepted by the expense acceptance unit, acquires a judgement result according to a machine learning algorithm, the learner receiving a receipt image as an input and acquiring a determination result that indicates whether the receipt image is unclear or clear.

With such a configuration, it is possible to perform an inspection regarding an unclear receipt image.

An expense inspection device according to the present invention is the above-described expense inspection device, wherein the external information includes company regulation information regarding regulations of a company to which the applicant belongs, the company regulation information includes payment means information that specifies an unacceptable payment method, and the image inspection part acquires payment means information that is a string, from a receipt image, and judges whether or not the payment means information is the payment means information included in the company regulation information, to acquire an image inspection result.

With such a configuration, it is possible to perform an inspection regarding an inappropriate payment means.

An expense inspection device according to the present invention is the above-described expense inspection device, wherein the image inspection part performs prediction processing according to a machine learning algorithm, using a learner and the receipt image accepted by the expense acceptance unit, to acquire an inspection result that indicates whether or not the amount of money written on the receipt image has been forged, the learner acquiring a judgment result indicating whether or not the amount of money has been forged based on an input receipt image, using one or more receipt images in which the amount of money has been forged by handwriting and one or more receipt images in which the amount of money has not been forged, according to a machine learning algorithm.

With such a configuration, it is possible to perform an inspection regarding forgery of the amount of expense by handwriting.

An expense inspection device according to the present invention is the above-described expense inspection device, wherein the external information or the expense information is associated with an organization identifier that identifies an organization, the expense acceptance unit accepts the expense information associated with the organization identifier from an expense management device, the inspection unit performs an inspection of improperness regarding the expense information accepted by the expense acceptance unit, using external information that is associated with an organization identifier, or expense information that is other than the expense information accepted by the expense acceptance unit and that is associated with an organization identifier, to acquire an inspection result, and the result output unit transmits the inspection result acquired by the inspection unit to the expense management device. Here, it is preferable that the expense acceptance unit accepts expense information that is associated with an organization identifier, from each of two or more expense management devices.

With such a configuration, it is possible to provide the expense management device with the function of inspecting expense applications.

### Advantageous Effects of Invention

With an expense inspection device according to the present invention, it is possible to appropriately perform an inspection regarding improper expense applications.

### BRIEF DESCRIPTION OF DRAWINGS

FIG. 1 is a conceptual diagram for an information system A according to a first embodiment.

FIG. 2 is a block diagram for the information system A according to the same.

FIG. 3 is a block diagram for an expense inspection device 1 that is included in the information system A according to the same.

FIG. 4 is a flowchart illustrating example operations of the expense inspection device 1 according to the same.

FIG. 5 is a flowchart illustrating an example of inspection processing according to the same.

FIG. 6 is a flowchart illustrating an example of statistical inspection processing according to the same.

FIG. 7 is a flowchart illustrating an example of omission inspection processing according to the same.

FIG. 8 is an example of an output according to the same.

FIG. 9 is an example of an output according to the same.

FIG. 10 is a block diagram for another system that includes the expense inspection device 1 according to the same.

FIG. 11 is a conceptual diagram for an information system B according to a second embodiment.

FIG. 12 is a block diagram for the information system B according to the same.

FIG. 13 is a block diagram for an expense management device 5 that is included in the information system B according to the same.

FIG. 14 is a flowchart illustrating example operations of the expense management device 5 according to the same.

FIG. 15 is a flowchart illustrating an example of contact processing according to the same.

FIG. 16 is a diagram showing an address management table according to the same.

FIG. 17 is a diagram showing an e-mail according to the same.

FIG. 18 is a diagram showing a web page indicating an improper application inspection result group according to the same.

FIG. 19 is a schematic diagram showing a computer system according to the above embodiments.

FIG. 20 is a block diagram for the computer system according to the same.

### DESCRIPTION OF EMBODIMENTS

Hereinafter, embodiments of an expense inspection device, etc. will be described below with reference to the drawings. Note that constituent elements indicated by the same reference numerals in the embodiments perform the same operations and therefore, repetitive description thereof may be omitted.

### First Embodiment

The present embodiment describes an information system that includes an expense inspection device that accepts expense information, performs an inspection regarding improper applications, using external information or expense information regarding the applications in the past, and outputs inspection results. Note that external information is information other than expense information, and includes, for example, an applicant group, which will be described later, a company regulation group, which will be described later, a restaurant group, which will be described later, a brothel group, which will be described later, a counterparty group, which will be described later, credit card usage expense information, which will be described later, and transportation means information, which will be described later. Also, the subjects of an improper application inspection are, for example, a business trip expense, a transportation expense, duplicate applications, reuse of a receipt, an accommodation expense, and an expense for an after-party.

The present embodiment describes an information system that includes an expense inspection device for performing an improper application inspection using statistical processing results that are based on pieces of information corresponding to two or more pieces of expense information, and outputting inspection results. Statistical processing results are, for example, the frequency of use of a specific store, the frequency of providing benefits to a specific counterparty, and the number of improper applications submitted by a specific person.

The present embodiment also describes an information system that includes an expense inspection device for inspecting whether or not an approver of an expense application satisfies requirements.

The present embodiment also describes an information system that includes an expense inspection device for inspecting receipt images. Note that examples of inspections of a receipt image include an inspection of an incomplete description on the receipt image, an inspection of a flawed time stamp on the receipt image, an inspection of the unclearness of the receipt image, an inspection of an inappropriate payment method written on the receipt image, and an inspection of a forged amount of expense handwritten on the receipt image.

Furthermore, the present embodiment describes an information system that includes an expense inspection device for detecting an omission of an expense application that is to be submitted, using external information.

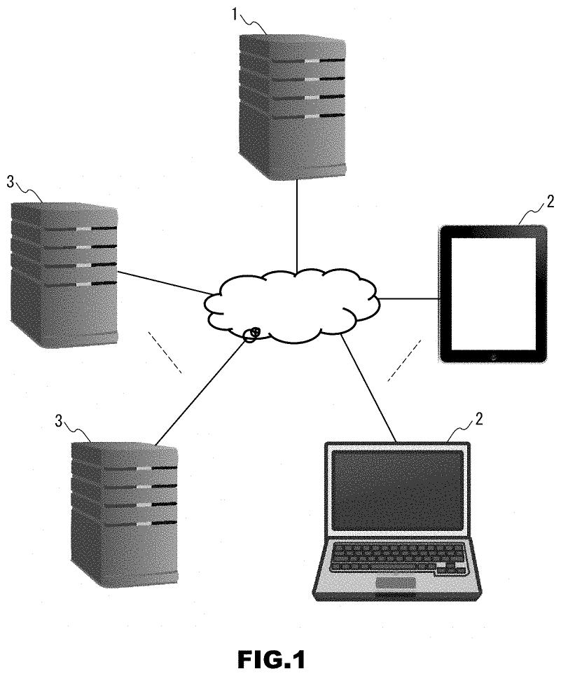

FIG. 1 is a conceptual diagram for an information system A according to the present embodiment. The information system A includes an expense inspection device 1, one or more applicant terminals 2, and one or more external servers 3.

The expense inspection device 1 is a device that inspects applied expense information. The expense inspection device 1 is typically a so-called server, such as a cloud server, an ASP server, or the like. Note that the type of the expense inspection device 1 is not limited.

Each applicant terminal 2 is a terminal used by an applicant. Each applicant is a user that applies for expenses. Each applicant terminal 2 is, for example, a so-called personal computer, a tablet terminal, a smart phone, or the like, and the type thereof is not limited.

Each external server 3 is a device that stores external information, which will be described later, and provides the external information to the expense inspection device 1. Note that all or some of the pieces of external information described later may be present in the expense inspection device 1. Also, if all of the pieces of external information described later are present in the expense inspection device 1, the external servers 3 are not required. Each external server 3 is typically a so-called server, such as a cloud server, an ASP server, or the like. Note that the type of each external server 3 is not limited.

The expense inspection device 1, the applicant terminals 2, and the external servers 3 are typically capable of communicating with each other via a network such as the Internet or a dedicated line.

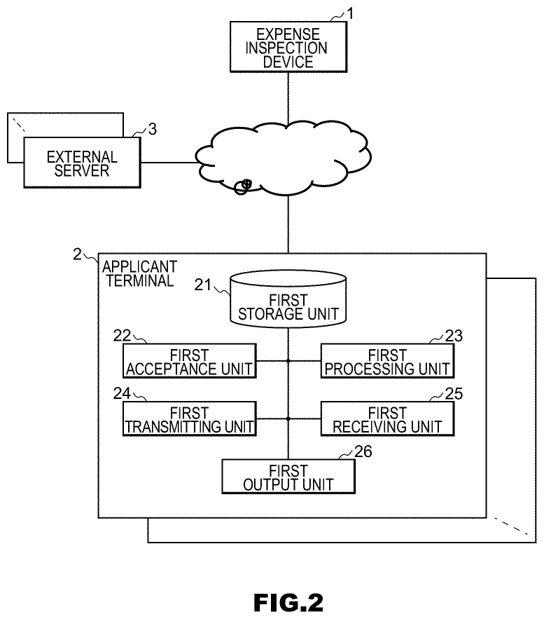

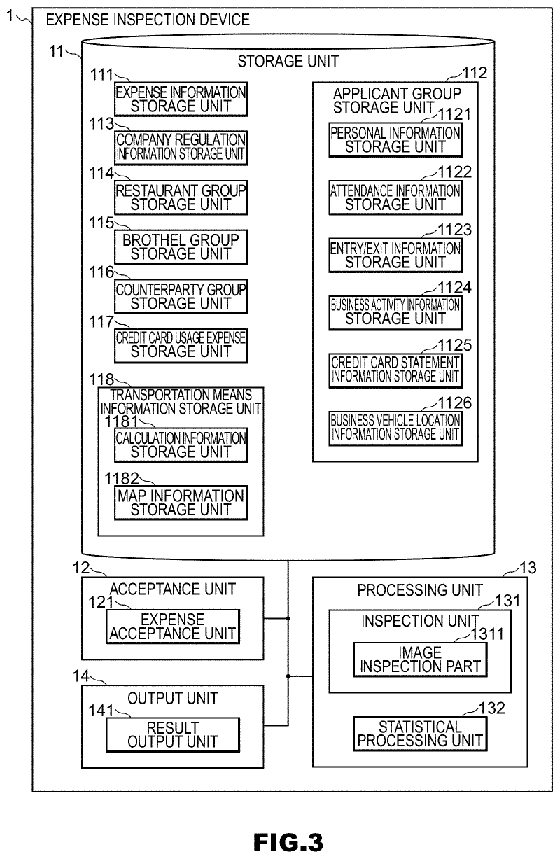

FIG. 2 is a block diagram for the information system A according to the present embodiment. FIG. 3 is a block diagram for the expense inspection device 1 included in the information system A.

The expense inspection device 1 includes a storage unit 11, an acceptance unit 12, a processing unit 13, and an output unit 14. The storage unit 11 includes, for example, an expense information storage unit 111, an applicant group storage unit 112, a company regulation information storage unit 113, a restaurant group storage unit 114, a brothel group storage unit 115, a counterparty group storage unit 116, a credit card usage expense storage unit 117, and a transportation means information storage unit 118. The applicant group storage unit 112 includes a personal information storage unit 1121, an attendance information storage unit 1122, an entry/exit information storage unit 1123, a business activity information storage unit 1124, a credit card statement information storage unit 1125, and a business vehicle location information storage unit 1126. The transportation means information storage unit 118 includes a calculation information storage unit 1181 and a map information storage unit 1182. The acceptance unit 12 includes an expense acceptance unit 121. The processing unit 13 includes an inspection unit 131 and a statistical processing unit 132. The inspection unit 131 includes an image inspection part 1311. The output unit 14 includes a result output unit 141.

Each applicant terminal 2 includes a first storage unit 21, a first acceptance unit 22, a first processing unit 23, a first transmitting unit 24, a first receiving unit 25, and a first output unit 26.

The expense information storage unit 111, the applicant group storage unit 112, the company regulation information storage unit 113, the restaurant group storage unit 114, the brothel group storage unit 115, the counterparty group storage unit 116, the credit card usage expense storage unit 117, and the transportation means information storage unit 118 included in the expense inspection device 1 may be included in another external device.

It is preferable that each external server 3 includes the restaurant group storage unit 114, the brothel group storage unit 115, the counterparty group storage unit 116, the credit card usage expense storage unit 117, and/or the transportation means information storage unit 118.

Note that the inspection unit 131 may use various pieces of information stored in the storage unit 11 to perform the inspection processing described later, or use various pieces of information stored in any external server 3 or information transmitted from the external server 3.

For example, a certain external server 3 is a server that receives a query that includes information identifying a departure station (an example of a departure identifier, which will be described later) and information identifying an arrival station (an example of an arrival identifier, which will be described later), and outputs one or more transportation expenses. Such an external server 3 includes the calculation information storage unit 1181 that stores fare calculation information, which will be described later. Examples of such an external server 3 include a Jorudan (registered trademark) server (URL “https://www.jorudan.co.jp/”) and a NAVITIME (registered trademark) server (URL “https://www.navitime.co.jp/”).

For example, a certain external server 3 is a server that receives a query that includes a departure identifier and an arrival identifier, and outputs a taxi fare. Such an external server 3 includes the calculation information storage unit 1181 that stores taxi fare calculation information, which will be described later, and the map information storage unit 1182. An example of such an external server 3 is a taxisite server (URL “https://www.taxisite.com/far/”).

The storage unit 11 stores various pieces of information. Example of the various pieces of information include expense information, which will be described later, and an external information, which will be described later.

The expense information storage unit 111 stores expense information. The expense information storage unit 111 typically stores two or more pieces of expense information. Expense information is information that specifies the details of the applied expense. Expense information includes, for example, spent-amount information, a destination identifier, a store identifier, a counterparty identifier, usage date information, a payment means identifier, a subject, a summary, and an approver identifier. Spent-amount information is information that specifies the amount spent as an expense. The destination identifier is information that indicates the destination of the receipt, and is information that identifies the company or the like that pays the amount. The store identifier is information that identifies the store where the expense was spent. The store identifier is, for example, a store name, a store ID, the URL of the store, or the phone number of the store. The counterparty identifier is information that specifies the counterparty for which the expense was spent. The counterparty identifier is information that identifies the party to which benefits such as entertainment or a gift were provided. The counterparty identifier is, for example, an organization name (for example, a company name or a group name), a name, or the ID of the counterparty. Usage date information is information that specifies the date when the expense was spent. Payment means identifier is information that identifies the payment means. The payment method identifier is, for example, “cash”, “credit card”, “electronic money”, “∘∘ PAY”, or the like. The subject is information that specifies the classification of the expense. The subject may also be referred to as an expense type identifier. The subject is, for example, a business trip expense, a travel transportation expense (or a transportation expense), an accommodation expense, a business trip expense, a reception and communication expense, or a meeting expense. The approver identifier is information that identifies the person approving the expense. The approver identifier is, for example, an applicant identifier or a position identifier. The applicant identifier is information that identifies the applicant that applied for the expense, which is a name or an ID, for example. The position identifier is information that identifies a position, which is, for example, a position name (for example, “department head” or “director”) or an ID. Each piece of expense information in the expense information storage unit 111 is typically associated with an applicant identifier.

When a piece of expense information is information regarding a transportation expense, the piece of expense information includes, for example, usage date information and transportation expense information that includes one or more pieces of section information that each include a departure identifier, an arrival identifier, and fare information. It is preferable that each piece of expense information includes an expense type identifier that indicates a transportation expense. When a piece of expense information is information regarding business trip expense, the piece of expense information includes, for example, usage date information. It is preferable that each piece of expense information includes an expense type identifier that indicates a business trip expense. When a piece of expense information is information regarding accommodation expense, the piece of expense information includes, for example, usage date information that specifies the date of stay at an accommodation facility. If a piece of expense information is information regarding a reception and communication expense or a meeting expense, the piece of expense information is associated with, for example, an applicant identifier, and includes usage date information and a store identifier that identifies the store where the expense was spent.

Expense information may include a receipt image. A receipt image is an image of a receipt. A receipt image is, for example, an image acquired by taking a picture of a receipt. Needless to say, the data structure of a receipt image may be JPEG, GIF, or the like, and is not limited.

Expense information includes, for example, participant information and participant number information. Participant information is information (for example, a name) that specifies a person that participated in the use of the expense (for example, a person that ate or drank). Participant number information is information regarding the number of people who participated in the use of the expense.

The applicant group storage unit 112 stores an applicant group. An applicant group is information unique to applicants corresponding thereto. The applicant group is, for example, a group of pieces of personal information, which will be described later, a group of pieces of attendance information, which will be described later, a group of pieces of entry/exit information, which will be described later, a group of business activity information, which will be described later, a group of pieces of credit card statement information, which will be described later, or a group of pieces of business vehicle location information, which will be described later.

The personal information storage unit 1121 stores one or more pieces of personal information. Personal information is information regarding an applicant. Each piece of personal information is associated with an applicant identifier. Each piece of personal information includes, for example, the applicant's name, a company name, a company ID, a department name, a department ID, a job title identifier that identifies the position of the applicant, commuter pass section information that specifies the section of the applicant's commuter pass, the number of improper applications, and an e-mail address. The number of improper applications is the number of times the applicant has submitted improper expense applications or the number of times the applicant's improper applications have been detected. The email address may be any information that specifies the destination of the information to be sent, such as an SNS ID, and is broadly understood.

Note that the fact that two pieces of information are associated may mean that one piece of information can be acquired from the other piece of information. For example, one piece of information and the other piece of information are linked, one piece of information and the other piece of information are stored in the same buffer, or one piece of information includes the other piece of information.

The attendance information storage unit 1122 stores one or more pieces of attendance information. Attendance information is information regarding the applicant's attendance. Attendance information is typically associated with an applicant identifier. Attendance information includes working day information. Working day information is information for specifying the days on which the applicant identified by the applicant identifier corresponding thereto worked. Working day information is typically information that indicates working days, but may be information that indicates non-working days. When working day information is information that indicates non-working days, days other than the days indicated by the working day information are working days. Attendance information typically includes working time information that specifies the hours the applicant worked. Working time information includes, for example, a work start time and a work end time. The attendance information in the attendance information storage unit 1122 is, for example, information received from one external server 3 (an attendance management server). The attendance management server (attendance management system) is a server that manages attendance of employees, and is a device according to a well-known technology, and therefore the detailed descriptions thereof will be omitted.

The entry/exit information storage unit 1123 stores one or more pieces of entry/exit information. Entry/exit information is information regarding the applicant's entry and exit. Entry and exit mean entry to and exit from the applicant's place of work (which may be referred to as a work location). Also, entry may be referred to as coming to the office to start working on a working day, and exit may be referred to as leaving the office after finishing working on a working day. Entry/exit information is typically associated with an applicant identifier. Entry/exit information includes, for example, working day information and working time information. Working time information includes, for example, a work start time and a work end time. Working time information includes, for example, information that specifies the hours the applicant worked. Entry/exit information is information that is formed by stamping a time card stamp or inputting information into the entry/exit system at entry to or exit from the office. Note that entry/exit information may be the same as attendance information. The entry/exit information in the entry/exit information storage unit 1123 is, for example, information received from one external server 3 (an entry/exit management server). The entry/exit management server (entry/exit management system) is a device according to a well-known technology, and therefore the detailed descriptions thereof will be omitted.

The business activity information storage unit 1124 stores one or more pieces of business activity information. Business activity information is information regarding business activities. Business activity information is, for example, information regarding daily business reports. Business activity information is typically associated with an applicant identifier. Business activity information includes business day information and one or more location identifiers. Business activity information may include a string or the like that indicates the content of the business activity. The business day information is information that specifies days on which the applicant performed business activities. A location identifier is information that specifies a visited location. A location identifier is, for example, (latitude, longitude), a company name, a location name, a place name, a station name, a bus stop name, or the like. The data structure of business activity information is not limited.

The credit card statement information storage unit 1125 stores one or more pieces of credit card statement information. credit card statement information is information that indicates the statement of the credit card used by the applicant. Credit card statement information is typically associated with an applicant identifier. Credit card statement information includes, for example, usage date information, a payment destination identifier (for example, a store identifier) for identifying the payment destination, amount information, and a card identifier. A card identifier is information that identifies a card, and is a card number, for example. The credit card statement information in the credit card statement information storage unit 1125 is, for example, information received from one external server 3 (a card management company server).

The business vehicle location information storage unit 1126 stores one or more pieces of business vehicle location information. Business vehicle location information is information that specifies the location of the business vehicle used by the applicant. Business vehicle location information is typically associated with an applicant identifier. Business vehicle location information is associated with usage date information that specifies the day on which the business vehicle was used. business vehicle location information is (latitude, longitude), for example, but may be a location identifier. Business vehicle location information is, for example, associated with a business vehicle location identifier that identifies the business vehicle.

Company regulation information storage unit 113 stores company regulation information. Company regulation information is information that indicates company regulations. Company regulation information is information regarding the regulations of the company to which the applicant belongs. Company regulation information includes, for example, overtime work time information, one or more pieces of approver information, and one or more pieces of payment method information.

Overtime work time information is information that specifies the time from which an overnight stay is permitted. The overtime work time information is, for example, “23:00” or “after 24:00”.

Approver information is information that specifies that a person can be an approver of the expense. Approver information is, for example, an approver identifier that specifies the approver (for example, applicant identifier, name) or a position identifier that specifies the approver's position (for example, “department head” or “director”).

Payment method information is information that specifies unacceptable payment methods. Payment method information indicates, for example, “00 PAY”, “electronic money”, and “credit card”.

The restaurant group storage unit 114 stores a restaurant group. The restaurant group stores one or more pieces of restaurant information. Restaurant information is information regarding restaurants. restaurant information includes, for example, a restaurant identifier that identifies a restaurant, and amount information. Restaurant information may include address information, telephone number information, and so on. The restaurant identifier is, for example, a restaurant name or an ID. Amount information is, for example, information that specifies an appropriate amount of money that can be spent at the restaurant. Amount information is, for example, information regarding the amount of money that can be spent by one person at the restaurant. Amount information is, for example, information regarding an average amount of money that can be spent by one person at the restaurant. Amount information may be, for example, information that specifies the upper limit of the amount of money that can be spent by one person at the restaurant. Amount information may be, for example, information that specifies the upper limit of the amount of money that can be used at one time.

The brothel group storage unit 115 stores a brothel group. The brothel group includes one or more pieces of brothel information. Brothel information includes, for example, a brothel identifier that identifies a brothel. Brothel information may include amount information, address information, telephone number information, and so on. Brothel information is, for example, information that specifies stores that the applicant is prohibited from visiting.

The counterparty group storage unit 116 stores a counterparty group. The counterparty group includes one or more pieces of counterparty information. Counterparty information includes, for example, a counterparty identifier and an organization identifier that identifies the organization to which the counterparty belongs. Counterparty information is, for example, information regarding public employees. Counterparty information is, for example, information regarding a councilor. Counterparty information is, for example, information that specifies a counterparty to which the applicant is prohibited from providing benefits. Note that the provision of benefits is, for example, the act of giving entertainment or a gift.

The credit card usage expense storage unit 117 stores one or more expense type identifiers of expenses scheduled to be paid by credit card. Each expense type identifier may be associated with a credit card type identifier. A credit card type identifier is information that identifies a credit card type. A credit card type identifier is, for example, “EX-IC card” or “corporate card”. Expense type identifier is, for example, “Shinkansen” that indicates a Shinkansen fare, or “reception and communication expense”.

The transportation means information storage unit 118 stores transportation means information. Transportation means information is information used to calculate transportation costs when transportation means such as a train, a bus, an airplane, or a taxi is used. Transportation information includes calculation information, which will be described later. Transportation means information includes, for example, map information, which will be described later.

The calculation information storage unit 1181 stores calculation information. Calculation information is, for example, fare calculation information or taxi fare calculation information. Fare calculation information is, for example, information used to calculate the fare for a transportation means such as a train, a bus, or an airplane. Fare calculation information is, for example, information that includes one or more sets that each consist of a departure identifier, an arrival identifier, and fare information. Each of the departure and the arrival identifiers is, for example, a station name, an airport name, a bus stop name, a station ID, an airport ID, or a bus stop ID. Taxi fare calculation information is information used to calculate a taxi fare. Taxi fare calculation information is, for example, an arithmetic expression used to calculate a taxi fare, using a distance as an input. Taxi fare calculation information is, for example, information that includes one or more sets that each consist of a distance and a taxi fare.

The map information storage unit 1182 stores map information. Map information is, for example, information regarding a map used for navigation. Map information is, for example, information in the KIWI format.

The acceptance unit 12 accepts various kinds of information and instructions. Acceptance here means reception from a terminal such as an applicant terminal 2 or the like. However, acceptance may be a concept that includes the acceptance of information input from an input device such as a keyboard, a mouse, or a touch panel, and the acceptance of information read out from a recording medium such as an optical disk, a magnetic disk, or a semiconductor memory.

The expense acceptance unit 121 accepts one or more pieces of expense information. The expense acceptance unit 121 typically accepts expense information in association with an applicant identifier. The expense acceptance unit 121 accepts, for example, expense information and an applicant identifier. The expense acceptance unit 121 may, for example, accept one or more pieces of expense information for each of one or more applicants. The acceptance of expense information is, for example, reception from an applicant terminal, but may be reception from an administrator terminal (not shown), reading out from a recording medium, or the acceptance of an input from an applicant.

It is preferable that the expense acceptance unit 121 accepts expense information that includes a receipt image. The expense acceptance unit 121 may separately accept a receipt image and information that is other than the receipt image and is included in expense information. However, a receipt image and information other than the receipt image are accepted in association with each other.

The processing unit 13 performs various kinds of processing. Examples of various kinds of processing include processing performed by the inspection unit 131 and the statistical processing unit 132.

The inspection unit 131 inspects improperness regarding the expense information accepted by the expense acceptance unit 121, to acquire an inspection result. The inspection unit 131 may inspect improperness regarding the expense information stored in the expense information storage unit 111, to acquire an inspection result. The expense information stored in the expense information storage unit 111 is the expense information accepted by the expense acceptance unit 121. An inspection result is information related to the result of the inspection of expense information. An inspection result includes, for example, information that indicates whether or not the expense is improper. An inspection result includes, for example, part or all of a piece of expense information that is improper. An inspection result is, for example, information indicating that an expense is not improper (proper). An inspection result includes, for example, one or more pieces of information from among an expense information identifier, an applicant identifier, an expense type identifier, amount information, an inspection detail identifier, an application date, and so on. The expense information identifier is information that identifies expense information, and is, for example, an ID. The inspection detail identifier is information that identifies the details of the inspection. The inspection detail identifier is, typically stored in the storage unit 11 in association with inspection processing, which will be described later. The inspection identifier is, for example, “non-work day expense”, “improper business trip expense”, “improper accommodation expense”, “accommodation expense on a day for which accommodation is not permitted”, “improper transportation expense”, or “receipt splitting”. The content of the inspection detail identifier, the data structure thereof, and so on are not limited.

For example, the inspection unit 131 inspects improperness regarding the expense information accepted by the expense acceptance unit 121, using external information, to acquire an inspection result. External information is information other than expense information. The external information used by the inspection unit 131 may be stored in the storage unit 11 of the expense inspection device 1 or an external server 3.

For example, the inspection unit 131 inspects improperness regarding the expense information accepted by the expense acceptance unit 121, using expense information other than the expense information accepted by the expense acceptance unit 121, to acquire an inspection result. Expense information other than the expense information accepted by the expense acceptance unit 121 is, for example, the expense information stored in the expense information storage unit 111, but may be expense information stored in an external server 3.

For example, the inspection unit 131 acquires applicant information that is associated with the applicant identifier associated with the expense information accepted by the expense acceptance unit 121, from the applicant group, and inspects improperness regarding the expense information accepted by the expense acceptance unit 121, using the applicant information, to acquire an inspection result. Note that the applicant group is, for example, information stored in the applicant group storage unit 112, but may be information stored in an external device (not shown). Applicant information is information associated with an applicant identifier, and is, for example, attendance information, entry/exit information, business activity information, credit card statement information, or business vehicle location information.

The image inspection part 1311 inspects the receipt image included in the expense information accepted by the expense acceptance unit 121, to acquire an image inspection result. Note that the image inspection result is an example of the inspection results.

The image inspection part 1311 acquires one or more strings from the receipt image, inspects whether or not the receipt image is proper using the one or more strings, to acquire an image inspection result. The image inspection part 1311 uses at least either character recognition processing or machine learning processing to acquire one or more strings from the receipt image.

In the present description, the algorithm used in machine learning processing is not limited. Machine learning is, for example, deep learning, a decision tree, a random forest, an SVM, an SVR, or the like. The modules used in machine learning are, for example, TensorFlow modules, TinySVM, or the like.

### (1) Method Using Character Recognition Processing

The image inspection part 1311 performs, for example, character recognition processing on the receipt image to acquire one or more strings. The technique for performing character recognition processing to acquire information that constitutes expense, information from a receipt image, is a well-known technique. Note that the image inspection part 1311 determines which information each acquired string indicates, from among payment amount information, a store identifier, a counterparty identifier, usage date information, a subject, a summary, and payment method information, and acquires the string in association with information that identifies the type (which may be referred to as a class, a category, or the like) of the information. The technique for determining the class of the acquired string is an information classification problem (clustering problem) and is a well-known technique.

For example, for each class, the image inspection part 1311 sets two or more strings belonging to the class as positive examples, and one or more strings not belonging to the class as negative examples, and performs leaning processing in machine learning, to form a learner that performs binary classification as to whether or not a string belongs to a class. Thereafter, the image inspection part 1311 performs machine learning prediction processing on each of the one or more strings acquired from the receipt image, using two or more learners, acquires prediction results and scores for the classes, and determines the class with the highest score as the class to which the string belongs.

In addition, the image inspection part 1311 performs learning processing, using training data that includes two or more sets that each consist of a string and a class, to form one learner that performs multilevel classification to output a class. Next, the image inspection part 1311 performs prediction processing of machine learning on one or more strings acquired from the receipt image, using a learner, and determines the class to which each string belongs.

For example, using a large amount of training data constituted by sets that each consist of a string and a class, the image inspection part 1311 acquires a learner for classifying strings, using a module for performing learning processing, from among machine learning algorithms.

### (2) Method Using Machine Learning Processing

For example, the image inspection part 1311 performs learning processing according to a machine learning algorithm, using two or more pieces of training data that include one or more sets that each consist of a receipt image, a string, and a class, to acquire a learner. Note that this learner is a learner to which a receipt image is input and that outputs one or more sets that each consist of a string and a class.

Next, the image inspection part 1311 supplies the acquired learner and the receipt image included in the expense information accepted by the expense acceptance unit 121 to a module that performs prediction processing from among machine learning algorithms, to acquire one or more sets that each consist of a string and a class.

### (3) Method Using Both Character Recognition Processing and Machine Learning Processing

For example, the image inspection part 1311 uses both (1) and (2) above to acquire a string for each class, and if there is no match in the processing (1) and (2) for the class, uses the score acquired through character recognition processing and the score acquired through machine learning processing, and acquires the string with a score that is high enough to satisfy a condition.

Also, using one or more strings acquired through any of the above methods (1) to (3), the image inspection part 1311 judges whether or not the one or more strings satisfy a predetermined condition, to acquire image inspection results. Each of the one or more strings is, for example, payment amount information, a store identifier, a counterparty identifier, a usage date information, a subject, a summary, or payment method information.

For example, using training data that includes negative examples that are one or more improper receipt images and positive examples that are one or more proper receipt images, to form a learner, the image inspection method 1311 performs learning processing according to a machine learning algorithm. Next, the image inspection part 1311 supplies the receipt image included in the expense information accepted by the expense acceptance unit 121 and the learner to the module that performs prediction processing of machine learning to perform prediction processing, and acquires a prediction result indicating whether or not the receipt image is improper. Note that the learner is, for example, a learner for detecting improper modification of the amount of money on the receipt, a learner for inspecting whether or not the receipt is signed, or a learner for detecting a blurred receipt image. In addition, the learner is typically a learner for binary classification regarding whether or not the receipt is improper.

The statistical processing unit 132 performs statistical processing based on one or more pieces of expense information that are associated with an applicant identifier associated with the accepted expense information and are stored in the expense information storage unit 111, to acquire statistical processing results. For example, the statistical processing unit 132 performs statistical processing for each applicant identifier, based on one or more pieces of expense information that are associated with the applicant identifier and are stored in the expense information storage unit, to acquire statistical processing results. Note that the timing with which the statistical processing unit 132 performs statistical processing is not limited. For example, the statistical processing unit 132 performs statistical processing upon accepting a user instruction. For example, the statistical processing unit 132 performs statistical processing upon accepting expense information.

For example, the statistical processing unit 132 acquires store frequency information, using store identifiers included in two or more pieces of expense information stored in the expense information storage unit 111 and associated with one applicant identifier. Store frequency information is information regarding the frequency of use of a store identified by one store identifier. Store frequency information is information indicating the frequency of use. For example, store frequency information is information indicating the total number of times the store has been used, or the number of times the store has been used per unit period. The unit period is, for example, one month, six months, or one year. It is preferable that the statistical processing unit 132 acquires store frequency information for each applicant identifier.

For example, the statistical processing unit 132 acquires store frequency information, using counterparty identifiers included in two or more pieces of expense information stored in the expense information storage unit 111 and associated with one applicant identifier. Entertainment frequency information is information regarding the frequency of spending for a counterparty identified by one counterparty identifier. Spending for a counterparty is payment for providing benefits to the counterparty, such as payment for entertainment to the counterparty, payment for a gift to the counterparty, or the like. Entertainment frequency information is information indicating the frequency of providing benefits. For example, entertainment frequency information is information indicating the total number of times benefits have been provided, or the number of times benefits have been provided per unit period. It is preferable that the statistical processing unit 132 acquires entertainment frequency information for each applicant identifier.

The statistical processing unit 132 acquires an improper application count that is the number of times an inspection result has been acquired, in association with one applicant identifier, where the inspection result is a result of the inspection of expense information corresponding to one applicant identifier and corresponds to an improper application. It is preferable that the statistical processing unit 132 acquires an improper application count for each applicant identifier.

The result output unit 141 outputs an inspection result acquired by the inspection unit 131. The result output unit 141 outputs an image inspection result acquired by the image inspection part 1311.

The result output unit 141 outputs a statistical processing result acquired by the statistical processing unit 132. For example, the result output unit 141 outputs a statistical processing result in association with an applicant identifier.

The first storage unit 21 included in each applicant terminal 2 stores various kinds of information. Examples of various kinds of information include an applicant identifier and expense information.

The first acceptance unit 22 accepts various kinds of instructions and information. Examples of various kinds of instructions and information includes expense information and response information. Response information is information indicating a response to an inspection result.

The first processing unit 23 performs various kinds of processing. Examples of various kinds of processing include processing that is performed to convert instructions and information accepted by the first acceptance unit 22 into instructions and information in the data structure to be transmitted. Examples of various kinds of information include processing that is performed to convert information received by the first receiving unit 25 into information in the data structure to be output.

The first transmitting unit 24 transmits various kinds of instructions and information. Examples of various kinds of instructions and information includes expense information, an applicant identifier, and response information.

The first receiving unit 25 receives various kinds of information. Examples of various kinds of information include an inspection result and an image inspection result.

The first output unit 26 outputs various kinds of information. Examples of various kinds of information include an inspection result and an image inspection result.

Here, “output” is a concept that includes displaying on a display device, projection with a projector, printing with a printer, sound output, transmission to an external device, accumulation on a recording medium, delivery of processing results to another processing apparatus or another program, and so on.

### Specific Examples of Inspection Processing

Specific examples of inspection performed by the inspection unit 131 will be described below. Although the following mainly describes the case of an improper application, if an application is not improper, the inspection unit 131 typically acquires an inspection result indicating that the application is “proper”. If an application is valid, the inspection unit 131 typically stores the inspected expense information in the expense information storage unit 111 in association with the applicant identifier.

Information included in expense information used by the inspection unit 131 to perform an inspection may be a string accepted by the expense acceptance unit 121 or information acquired from a receipt image accepted by the expense acceptance unit 121. The string accepted by the expense acceptance unit 121 is, for example, information input by an applicant.

### (1) Inspection Using Attendance Information

For example, the inspection unit 131 acquires, from the attendance information storage unit 1122, attendance information that is associated with the applicant identifier associated with the expense information accepted by the expense acceptance unit 121 and that includes working day information that is the same as the usage date information included in the expense information accepted by the expense acceptance unit 121. Next, the inspection unit 131 inspects improperness regarding the expense information accepted by the expense acceptance unit 121, using the attendance information, to acquire an inspection result.

(1-1) Inspection of Expenses on a Day Other than Working Days

For example, the inspection unit 131 acquires, from the attendance information storage unit 1122, attendance information that is associated with the applicant identifier associated with the expense information accepted by the expense acceptance unit 121 and that includes working day information that is the same as the usage date information included in the expense information accepted by the expense acceptance unit 121. Next, the inspection unit 131 judges whether or not the attendance information is information regarding a non-working day. If the information is information regarding a non-working day, the inspection unit 131 acquires an inspection result indicating “an improper expense on a non-working day”. Note that the inspection unit 131 judges that attendance information is information regarding a day that is not a working day based on the fact that the attendance information includes “information indicating a holiday” or the fact that the attendance information does not include a work start time or a work end time, for example.

### (1-2) Inspection of Improperness Regarding Business Trip Expense

The inspection unit 131 acquires the applicant identifier and the usage date information associated with the expense information accepted by the expense acceptance unit 121. Next, the inspection unit 131 acquires the attendance information corresponding to the acquired applicant identifier and usage date information, from the attendance information storage unit 1122. Next, if the inspection unit 131 judges that the acquired attendance information is not information that indicates a business trip, the inspection unit 131 acquires an inspection result indicating “an improper fictitious business trip”. Examples of cases where “attendance information is not information that indicates a business trip” include (a) the case where information indicating “business trip” is not included in the attendance information, (b) the case where the attendance information includes information regarding a work start time and a work end time, and so on.

### (1-3) Inspection of Improperness Regarding Accommodation Expense

The inspection unit 131 acquires the applicant identifier and the usage date information associated with the expense information accepted by the expense acceptance unit 121. Next, the inspection unit 131 acquires working time information from the working day information corresponding to the acquired applicant identifier and usage date information. Next, the inspection unit 131 judges whether or not an overnight stay at an accommodation facility is permitted, using the acquired working time information, to acquire an inspection result.

More specifically, the inspection unit 131 compares the work end time included in the working time information with the overtime work time information indicating the overtime hour from which an overnight stay is permitted, and judges whether or not a predetermined accommodation condition is satisfied. If the inspection unit 131 judges that the accommodation condition is not satisfied, the inspection unit 131 acquires an inspection result indicating “an improper application for an accommodation expense”. Note that the accommodation condition is a condition that uses overtime work time information and a work end time, and is “overtime work time information=<work end time” or “overtime work time information<work end time”, for example.

### (2) Inspection Using Entry/Exit Information

The inspection unit 131 acquires, from the entry/exit information storage unit 1123, entry/exit information that is associated with the applicant identifier associated with the expense information, and that corresponds to the day specified by the usage date information included in the expense information, and performs an inspection of improperness regarding the expense information accepted by the expense acceptance unit 121, using the entry/exit information, to acquire an inspection result.

(2-1) Inspection of Expense on a Day Other than Working Days

The inspection unit 131 acquires the applicant identifier and the usage date information associated with the expense information accepted by the expense acceptance unit 121. Next, the inspection unit 131 acquires the entry/exit information corresponding to the acquired applicant identifier and usage date information, from the entry/exit information storage unit 1123. Next, the inspection unit 131 judges whether or not the entry/exit information is information regarding a non-working day. If the information is information regarding a non-working day, the inspection unit 131 acquires an inspection result indicating “an improper expense on a non-working day”. Note that the inspection unit 131 judges that entry/exit information is information regarding a day that is not a working day based on the fact that the entry/exit information includes “information indicating a holiday” or the fact that the entry/exit information does not include a work start time or a work end time, for example.

### (2-2) Inspection of Improperness Regarding Business Trip Expense

The inspection unit 131 acquires the applicant identifier and the usage date information associated with the expense information accepted by the expense acceptance unit 121. Next, the inspection unit 131 acquires the entry/exit information corresponding to the acquired applicant identifier and usage date information, from the entry/exit information storage unit 1123. Next, if the inspection unit 131 judges that the acquired entry/exit information is not information that indicates a business trip, the inspection unit 131 acquires an inspection result indicating “an improper fictitious business trip”. Examples of cases where “entry/exit information is not information that indicates a business trip” include (a) the case where information indicating “business trip” is not included in the attendance information, (b) the case where the attendance information includes information regarding a work start time and a work end time, and so on. Note that work start time information and work end time information for normal work are included in company regulation information, for example.

### (2-3) Inspection of Improperness Regarding Accommodation Expense

The inspection unit 131 acquires the applicant identifier and the usage date information associated with the expense information accepted by the expense acceptance unit 121. Next, the inspection unit 131 acquires a work end time from the entry/exit information corresponding to the acquired applicant identifier and usage date information. Next, the inspection unit 131 judges whether or not an overnight stay at an accommodation facility is permitted, using the acquired work end time, to acquire an inspection result.

More specifically, the inspection unit 131 compares the work end time with the overtime work time information indicating the overtime work time from which an overnight stay is permitted, and judges whether or not a predetermined accommodation condition is satisfied. If the inspection unit 131 judges that the accommodation condition is not satisfied, the inspection unit 131 acquires an inspection result indicating “an improper application for an accommodation expense”. Note that overtime time work time information is included in company regulation information, for example.

### (3) Inspection Using Business Activity Information

The inspection unit 131 acquires, from the business activity information storage unit 1124, one or more location identifiers that are included in the business activity information associated with the applicant identifier associated with the expense information accepted by the expense acceptance unit 121, and that include business day information that is the same as the usage date information included in the expense information. Next, using the one or more location identifiers, the inspection unit 131 inspects improperness regarding the expense information accepted by the expense acceptance unit 121, to acquire an inspection result.

### (3-1) Inspection of Improperness Regarding Transportation Expense (i)

The inspection unit 131 provides information that indicates the location of the company and one or more location identifiers included in business activity information to a transportation expense calculation module, and acquires one or more transportation expenses, using calculation information for calculating transportation expenses. It is preferable that the transportation expenses acquired here are the lowest transportation expenses. The cases where two or more transportation expenses are to be acquired are cases where there are two or more travel routes. The technology for acquiring transportation expenses and the technology for acquiring the lowest transportation expense are well-known technologies, and therefore the detailed descriptions thereof will be omitted. The inspection unit 131 acquires spent-amount information from the expense information accepted by the expense acceptance unit 121.

Next, using the spent-amount information and the acquired transportation expense, the inspection unit 131 judges whether or not the spent-amount information satisfies a predetermined condition for a proper transportation expense. If the predetermined condition for a proper transportation expense is not satisfied, the inspection unit 131 acquires an inspection result indicating “improper transportation expense application”. Note that the condition for a proper transportation expense is, for example, “spent-amount information=lowest transportation expense”, “spent-amount information matches any of the one or more transportation expenses”, or “spent-amount information<=any of the one or more transportation expenses”.

### (3-2) Inspection of Improperness Regarding Transportation Expense (ii)

The inspection unit 131 acquires transportation expense information that includes a departure identifier and an arrival identifier, from the expense information accepted by the expense acceptance unit 121. Also, the inspection unit 131 acquires one or more location identifiers included in business activity information. Thereafter, the inspection unit 131 judges whether or not the distance between the departure identifier and any of the location identifiers is short enough to satisfy a predetermined condition. If the distance between the departure identifier and none of the location identifiers satisfies the predetermined condition, the inspection unit 131 acquires an inspection result indicating “an improper application for a transportation expense”. The inspection unit 131 judges whether or not the distance between the arrival identifier and any of the location identifiers is short enough to satisfy a predetermined condition. If the distance between the arrival identifier and none of the location identifiers satisfies the predetermined condition, the inspection unit 131 acquires an inspection result indicating “an improper application for a transportation expense”.

Note that the techniques for calculating the distance between a departure identifier or an arrival identifier and each location identifier is a well-known technique.

### (4) Inspection Using Credit Card Statement Information

The inspection unit 131 acquires, from the credit card statement information storage unit 1125, credit card statement information that is associated with the applicant identifier associated with the expense information accepted by the expense acceptance unit 121 and that includes usage date information that is the same as the usage date information included in the expense information. Using the credit card statement information, the inspection unit 131 inspects improperness regarding the expense information accepted by the expense acceptance unit 121, to acquire an inspection result.

### (4-1) Inspection of Receipt Splitting

The inspection unit 131 acquires, from the credit card statement information storage unit 1125, credit card statement information that is associated with the applicant identifier associated with the expense information accepted by the expense acceptance unit 121 and that includes usage date information that is the same as the usage date information included in the expense information. Thereafter, upon determining that two or more pieces of credit card statement information are successfully acquired and the store identifiers included in the two or more pieces of credit card statement information are the same, the inspection unit 131 acquires an inspection result indicating “improper receipt splitting”.

(4-2) Inspection of Taxi Use after Company Drinking Party

The inspection unit 131 acquires credit card statement information associated with the applicant identifier associated with the expense information accepted by the expense acceptance unit 121. Also, the inspection unit 131 judges whether or not the expense is for using a taxi, using information included in the credit card statement information. If the expense is for using a taxi, the inspection unit 131 acquires one or more pieces of participant information (for example, participant names) included in the expense information that includes usage date information that is the same as the usage date information included in the credit card statement information. Next, the inspection unit 131 judges whether or not all of the one or more pieces of participant information correspond to personal information stored in in the personal information storage unit 1121 (employee database) (for example, whether or not the names of the participants are included). Thereafter, if all of the one or more pieces of participant information correspond to the personal information, the inspection unit 131 acquires an inspection result indicating “a taxi use after company drinking party”.

### (5) Inspection Using Business Vehicle Location Information

The inspection unit 131 acquires, from the business vehicle location information storage unit 1126, one or more pieces of business vehicle location information that are associated with the applicant identifier associated with the expense information accepted by the expense acceptance unit 121 and that are associated with usage date information that is the same as the usage date information included in the expense information. Next, using the business vehicle location information, the inspection unit 131 performs an inspection of improperness regarding the expense information, to acquire an inspection result.

### (5-1) Inspection of Improper Use of Business Vehicle (Inspection of Improper Location)

The inspection unit 131 judges whether or not the distance from the one or more pieces of business vehicle location information thus acquired to a predetermined improper location (for example, a tourist spot) is short enough to satisfy a predetermined condition. Upon determining that the distance is short enough to satisfy the predetermined condition, the inspection unit 131 acquires an inspection result indicating “improper use of a business vehicle”. Note that information regarding a predetermined improper location is included in company regulation information, for example.

### (6) Inspection Using Credit Card Usage Expense Information

The inspection unit 131 performs an inspection to judge whether or not the expense type identifier associated with the expense information accepted by the expense acceptance unit 121 is stored in the credit card usage expense storage unit 117 as an expense type identifier associated with owned card information associated with the applicant identifier associated with the expense information accepted by the expense acceptance unit 121, to acquire an inspection result. For example, it is assumed that information indicating that a credit card is to be used for food and drink or entertainment is stored in the credit card usage expense storage unit 117.

### (7) Inspection Using Company Regulation Information

Using the company regulation information stored in the company regulation information storage unit 113, the inspection unit 131 performs an inspection to judge whether or not the expense information accepted by the expense acceptance unit 121 matches the company regulations specified by the company regulation information, to acquire an inspection result. Note that specific examples of inspections using company regulation information are shown in (2-2) and (2-3), (13-1) and (13-2) described later, (14-3)(a) described later, and (14-4)(a) described later.

### (8) Inspection Using Transportation Means Information

Using the expense information accepted by the expense acceptance unit 121 and the transportation means information stored in the transportation means information storage unit 118, the inspection unit 131 inspects improperness regarding a transportation expense, to acquire an inspection result.

### (8-1) Inspection of Improperness Regarding Transportation Expense for Train, Bus, or Plane

The inspection unit 131 acquires applicant information associated with the applicant identifier associated with the expense information regarding a transportation expense accepted by the expense acceptance unit 121, and performs an inspection of improperness regarding an application for the transportation expense, using the applicant information, or the applicant information and the transportation means information, to acquire an inspection result.

More specifically, the inspection unit 131 acquires transportation expense information that includes one or more pieces of section information that include a departure identifier, an arrival identifier, and fare information, from the expense information accepted by the expense acceptance unit 121. Next, the departure identifier and the arrival identifier of one or more pieces of section information are supplied to the transportation expense calculation module, and acquires one or more transportation expenses is acquired, using calculation information for calculating transportation expenses. It is preferable that the transportation expenses acquired here are the lowest transportation expenses. The cases where two or more transportation expenses are to be acquired are cases where there are two or more travel routes. The technology for acquiring transportation expenses and the technology for acquiring the lowest transportation expense are well-known technologies, and therefore the detailed descriptions thereof will be omitted. It is also preferable that the transportation expenses are acquired using an external server 3.

The inspection unit 131 acquires spent-amount information from the expense information accepted by the expense acceptance unit 121.

Next, using the fare information and the transportation expense, the inspection unit 131 judges whether or not the fare information satisfies a predetermined condition for a proper transportation expense. If the predetermined condition for a proper transportation expense is not satisfied, the inspection unit 131 acquires an inspection result indicating “improper transportation expense application”. Note that the condition for a proper transportation expense is, for example, “fare information=lowest transportation expense”, “fare information matches any of the one or more transportation expenses”, or “fare information<=any of the one or more transportation expenses”.

### (8-2) Inspection of Improperness Regarding Taxi Fare

The inspection unit 131 acquires applicant information associated with the applicant identifier associated with the expense information regarding a taxi fare accepted by the expense acceptance unit 121, and performs an inspection of improperness regarding an application for the transportation expense, using the applicant information, or the applicant information and the transportation means information, to acquire an inspection result.

More specifically, the inspection unit 131 acquires transportation expense information that includes a departure identifier, an arrival identifier, and spent-amount information, from the expense information accepted by the expense acceptance unit 121. Next, the inspection unit 131 acquires a travel distance, using the departure identifier, arrival identifier, and map information included in the transportation expense information. Next, the inspection unit 131 acquires a taxi fare, using the distance and calculation information for calculating a taxi fare. Here, the technology for acquiring the taxi fare is a well-known technology, and therefore the detailed descriptions thereof will be omitted. It is also preferable that the taxi fare is acquired using an external server 3.

The inspection unit 131 acquires spent-amount information from the expense information accepted by the expense acceptance unit 121.

Next, using the spent-amount information and the taxi fare, the inspection unit 131 judges whether or not the spent-amount information satisfies a predetermined condition for a proper taxi fare. If the predetermined condition for a proper taxi fare is not satisfied, the inspection unit 131 acquires an inspection result indicating “improper transportation expense application”. Note that the condition for a proper transportation expense is, for example, “spent-amount information=taxi fare”, “spent-amount information—taxi fare<=threshold value”, or “spent-amount information—taxi fare<threshold value”.

(8-3) Inspection of Overlap with Commuter Pass Section

The inspection unit 131 acquires, from the personal information storage unit 1121, commuter pass section information that is associated with the applicant identifier associated with the expense information regarding the transportation expense accepted by the expense acceptance unit 121. Next, the inspection unit 131 acquires transportation expense information that includes one or more pieces of section information that include a departure identifier and an arrival identifier, from the expense information accepted by the expense acceptance unit 121.

Next, the inspection unit 131 judges whether or not the section specified by the commuter pass section information overlaps the sections specified by the one or more pieces of section information, using transportation means information. For example, the inspection unit 131 acquires a set of station names (a station name group 1) in which station names in one or more sections included in each piece of section information are arranged in order, using the transportation means information. Thereafter, the inspection unit 131 acquires a set of station names (a station name group 2) in which the station names in the section specified by the commuter pass section information are arranged in order, using the transportation means information. Thereafter, the inspection unit 131 judges whether or not two or more consecutive identical station names are included in the station name group 1 and the station name group 2. If two or more consecutive identical station names are included, the inspection unit 131 acquires an inspection result indicating “applied transportation expense includes a commuter pass section”.

### (9) Inspection Using Store Information

Using a store identifier that is included in the expense information accepted by the expense acceptance unit 121 and store information that is included in a store group, the inspection unit 131 inspects improperness regarding expense information to acquire an inspection result. For example, the store group is the restaurant group stored in the restaurant set storage unit 114 or the restaurant group stored in the brothel group storage unit 115, but may be a restaurant group or a brothel group stored in an external device (not shown).

### (9-1) Inspection of Improperness Regarding Store (Use of Brothel or the Like)

For example, the inspection unit 131 acquires a store identifier that is included in the expense information accepted by the expense acceptance unit 121. Next, the inspection unit 131 inspects whether or not the acquired store identifier (brothel identifier) is stored in the brothel group storage unit 115, and if the acquired store identifier is stored, the inspection unit 131 acquires an inspection result indicating “improper use of expenses at a brothel that should not be visited”. It is preferable that such an inspection result includes brothel information that includes the store identifier in the brothel group storage unit 115.

### (9-2) Inspection of Improperness Regarding Amount

### (a) Inspection of Entire Amount

For example, the inspection unit 131 acquires amount information that is paired with the store identifier included in the expense information accepted by the expense acceptance unit 121, from the restaurant group storage unit 114. For example, the inspection unit 131 acquires spent-amount information that is included in the expense information accepted by the expense acceptance unit 121. Next, the inspection unit 131 compares the acquired spent-amount information with the acquired amount information, and judges whether or not the information indicates an amount that is high enough to satisfy a predetermined condition. If the information indicates an amount that is high enough to satisfy the predetermined condition, the inspection unit 131 acquires an inspection result indicating “improper amount of expense was used”. Note that the predetermined condition is, for example, “spent-amount information—amount information>=threshold value”, “spent-amount information—amount information>threshold value”, “spent-amount information/amount information>=threshold value”, or “spent-amount information/amount information>threshold value”. Note that the threshold values may be different from each other.

### (9-3) Inspection of Whether or not Entertainment Expense is for Use of Restaurant

For example, the inspection unit 131 acquires an expense type identifier that is included in the expense information accepted by the expense acceptance unit 121. Next, the inspection unit 131 judges whether or not the expense type identifier indicates “entertainment expense”. If the expense type identifier indicates “entertainment expense”, the inspection unit 131 acquires a store identifier that is included in the expense information accepted by the expense acceptance unit 121. Next, the inspection unit 131 judges whether or not the store identifier is a restaurant identifier. If the store identifier is not a restaurant identifier, the inspection unit 131 acquires an inspection result indicating “application for improper entertainment expense”.

For example, the inspection unit 131 judges whether or not the store identifier is a restaurant identifier based on whether or not the store identifier is stored in the restaurant group storage unit 114. Alternatively, for example, the inspection unit 131 performs a web search using the store identifier as a key, and judges whether or not the store identifier is an identifier of a restaurant based on whether or not the acquired web page contains information indicating a restaurant (for example, an izakaya, an Italian restaurant, a dish name, or the like). Other methods may be used for clustering store identifiers. In other words, the algorithm for determining whether or not the store identifier is a restaurant identifier is not limited.

### (b) Inspection of Amount Per Person

For example, the inspection unit 131 acquires amount information that is paired with the store identifier included in the expense information accepted by the expense acceptance unit 121, from the restaurant group storage unit 114. For example, the inspection unit 131 acquires spent-amount information that is included in the expense information accepted by the expense acceptance unit 121. Also, for example, the inspection unit 131 acquires participant number information that is included in the expense information accepted by the expense acceptance unit 121, or participant number information that is acquired from the participant information included in the expense information. Next, using the acquired spent-amount information, the acquired amount information, and the participant number information, the inspection unit 131 judges whether or not the amount per person is high enough to satisfy a predetermined condition. If the information indicates an amount per person that is high enough to satisfy the predetermined condition, the inspection unit 131 acquires an inspection result indicating “improper amount of expense was used”. Note that the predetermined condition is, for example, “(spent-amount information/participant number information)−amount information>=threshold value”, “(spent-amount information/participant number information)−amount information>threshold value”, “(spent-amount information/participant number information)/amount information>=threshold value”, or “(spent-amount information/participant number information)/amount information>threshold value”. Note that the threshold values may be different from each other.

### (10) Inspection Using Counterparty Information

Using a counterparty identifier that is included in the expense information accepted by the expense acceptance unit 121 and one or more pieces of counterparty information that are included in external information, the inspection unit 131 inspects improperness regarding expense information to acquire an inspection result. Note that the one or more pieces of counterparty information constitute a counterparty group, for example. The counterparty group is, for example, the counterparty group stored in the counterparty group storage unit 116.

### (10-1) Inspection of Provision of Benefits to Public Employees

The inspection unit 131 acquires a counterparty identifier that is included in the expense information accepted by the expense acceptance unit 121. Next, the inspection unit 131 judges whether or not the acquired counterparty identifier is present in the counterparty group storage unit 116 in which information regarding public employees is stored. If the acquired counterparty identifier is present, the inspection unit 131 acquires an inspection result indicating “improperness regarding provision of benefits to public employees”.

### (10-2) Inspection of Provision of Benefits to Government Officials

The inspection unit 131 acquires a counterparty identifier that is included in the expense information accepted by the expense acceptance unit 121. Next, the inspection unit 131 judges whether or not the acquired counterparty identifier is present in the counterparty group storage unit 116 in which information regarding government officials is stored. If the acquired counterparty identifier is present, the inspection unit 131 acquires an inspection result indicating “improperness regarding provision of benefits to government officials”.

### (11) Inspection Using Past Expense Information

### (11-1) Inspection of Duplicate Applications

The inspection unit 131 judges whether or not the expense information accepted by the expense acceptance unit 121 and one or more pieces of expense information in the past stored in the expense information storage unit 111 in association with the applicant identifier that is the same as the applicant identifier associated with the expense information are similar enough to satisfy a predetermined condition, to acquire an inspection result.

The fact that two pieces of expense information are “similar enough to satisfy a predetermined condition” means, for example, that, from among the spent-amount information, the store identifier, the counterparty identifier, the usage date information, the subject, the summary, and the approver identifier included in the expense information accepted by the expense acceptance unit 121, (a) a predetermined number or more pieces of information are the same, or (b) all of one or more predetermined pieces of information are the same, for example. Note that one or more pieces of predetermined information are one or more pieces of information of the spent-amount information, the store identifier, and the counterparty identifier included in the expense information accepted by the expense acceptance unit 121.

### (11-2) Inspection of Reuse of Receipt

Upon determining that the receipt image included in the expense information accepted by the expense acceptance unit 121 and a receipt image included in the past expense information stored in the expense information storage unit 111 are similar enough to satisfy a predetermined condition, the inspection unit 131 acquires an inspection result indicating “improperness regarding reuse of a receipt”. It is preferable that the receipt image included in the past expense information used by the inspection unit 131 to perform an inspection is the receipt image associated with the applicant identifier that is the same as the applicant identifier associated with the expense information accepted by the expense acceptance unit 121 (a receipt image used by the applicant in the past). However, the receipt image may be associated with another applicant identifier. Specifically, for example, reuse of a receipt is inspected using either one of the methods (a) and (b) shown below.

(a) Case in which Image Similarity is Used

For example, the inspection unit 131 acquires the degree of similarity between the receipt image included in the expense information accepted by the expense acceptance unit 121 and the receipt image included in one or more pieces of past expense information stored in the expense information storage unit 111, and if the degree of similarity is no less than or greater than a threshold value, the inspection unit 131 acquires an inspection result indicating “improperness regarding reuse of a receipt”. Note that the inspection result may include past expense information that has been judged as reuse, a receipt image included in the past expense information that has been judged as reuse, or the like.

(b) Case in which Machine Learning is Used

For example, using training data that includes one or more sets of two receipt images judged by a person to be reused receipts as positive examples, and one or more sets of two different receipt images as negative examples, the inspection unit 131 forms a learner through learning processing in machine learning. Note that such a learner is a learner that outputs a result indicating whether or not the same receipt has been reused (whether or not the receipts are the same).

Next, using the learner, the receipt image included in the expense information accepted by the expense acceptance unit 121, and the past receipt image in the expense information storage unit 111, the inspection unit 131 performs prediction processing in machine learning, and upon acquiring an output result indicating reuse, acquires an inspection result indicating “improperness regarding reuse of a receipt”. The past receipt image in the expense information storage unit 111 is preferably a receipt image associated with the applicant identifier corresponding to the expense information accepted by the expense acceptance unit 121.

### (11-3) Inspection of Submission of Large Number of Expense Applications on Same Day

The inspection unit 131 inspects two or more pieces of expense information that are associated with one applicant identifier and judges whether or not the number of pieces of expense information that include the same usage date information is large enough to satisfy a predetermined condition, to acquire an inspection result. If the number of pieces of expense information is large enough to satisfy the predetermined condition, the inspection unit 131 acquires an inspection result indicating improper applications.

Note that the number of pieces of expense information that are associated with one applicant identifier and have the same usage date information may be acquired by the statistical processing unit 132.

### (11-4) Inspection of Improperness Regarding Expense for After-Party

The inspection unit 131 inspects two or more pieces of expense information that are associated with one applicant identifier and judges whether or not the number of pieces of expense information that include the same usage date information and different restaurant identifiers is large enough to satisfy a predetermined condition, to acquire an inspection result. For example, if there are two or more applications for a restaurant expense on the same day, it means that the expense is used even for the after-party, and an inspection result indicating “improperness regarding expense for after-party” is acquired.

### (12) Inspection Using Statistical Processing Result

The inspection unit 131 performs an inspection to judge whether or not the statistical processing result acquired by the statistical processing unit 132 satisfies a predetermined condition, to acquire an inspection result.

### (12-1) Inspection Using Store Frequency Information

The inspection unit 131 performs an inspection to judge whether or not the store frequency information acquired by the statistical processing unit 132 is large enough to satisfy a predetermined condition, to acquire an inspection result. If the store frequency information has a value large enough to satisfy a store frequency condition that is a predetermined condition, the inspection unit 131 acquires an inspection result indicating “one store is used too frequently”. The store frequency condition is an example of an improperness condition. The store frequency condition is, for example, “store frequency information>=threshold value” or “store frequency information>threshold value”. For example, the store frequency condition is stored in the storage unit 11.

### (12-2) Inspection Using Entertainment Frequency Information

The inspection unit 131 performs an inspection to judge whether or not the entertainment frequency information acquired by the statistical processing unit 132 satisfies a predetermined condition, to acquire an inspection result. If the entertainment frequency information has a value large enough to satisfy an entertainment frequency condition that is a predetermined condition, the inspection unit 131 acquires an inspection result indicating “the number of times of entertainment or the like for counterparty is too large (for example, there is a possibility of collusion)”. The entertainment frequency condition is an example of an improperness condition. The entertainment frequency condition is, for example, “entertainment frequency information>=threshold value” or “entertainment frequency information>threshold value”. For example, the entertainment frequency condition is stored in the storage unit 11.

(12-3) Inspection of Number of Improper Applications from One Applicant

The inspection unit 131 inspects whether or not the number of improper applications acquired by the statistical processing unit 132 satisfies an improper application count condition that is a predetermined condition, and acquires an inspection result indicating “the number of improper applications from the applicant is large”. The predetermined condition is, for example, “the number of improper applications so far is greater than or equal to a threshold value” or “the number of improper applications during a unit period (for example, 1 year or 3 years) is greater than or equal to a threshold value”. Note that the improper application count condition is an example of an improperness condition. The improper application count condition is, for example, “improper application count>=threshold value” or “improper application count>threshold value”. For example, the improper application count condition is stored in the storage unit 11.

### (13) Detection of Improperness Regarding Expense Application Approver

The inspection unit 131 inspects whether or not the approver identified by the approver identifier included in the accepted expense information is the approver specified by approver information, to acquire an inspection result.

(13-1) Case in which Approvers Who can Approve are Under Control

For example, the inspection unit 131 judges whether or not the approver identifier included in the accepted expense information is included in approver information that is included in the company regulation information in the company regulation information storage unit 113, and upon determining that the approver identifier is not included, the inspection unit 131 acquires an inspection result indicating “improper approver”.

(13-2) Case in which Approver Positions are Under Control

For example, the inspection unit 131 acquires, from the personal information storage unit 1121, the position identifier paired with the approver identifier included in the accepted expense information. For example, the inspection unit 131 judges whether or not the position identifier is included in approver information included in the company regulation information in the company regulation information storage unit 113, and upon determining that the position identifier is not included, the inspection unit 131 acquires an inspection result indicating “improper approver”.

### (14) Detection of Omission of Application

Using the applicant information corresponding to one applicant identifier, the inspection unit 131 judges whether or not the expense information corresponding to the applicant information is present in the expense information storage unit 111 in which one or more pieces of expense information associated with one applicant identifier are stored, to perform an application omission inspection to judge whether or not an expense application corresponding to the applicant information has been performed, and acquires an inspection result. Note that applicant information is, for example, attendance information, entry/exit information, business activity information, credit card statement information, or business vehicle location information.

### (14-1) Detection of Omission of Application Using Attendance Information

### (a) Omission of Application for Labor Wage Expense

The inspection unit 131 acquires attendance information corresponding to one applicant identifier, from the attendance information storage unit 1122. Next, the inspection unit 131 judges whether or not the acquired attendance information corresponds to attendance that does not fall within the salary range. Next, upon determining that the attendance information is information corresponding to attendance that does not fall within the salary range, the inspection unit 131 judges whether or not expense information that corresponds to one applicant identifier, that includes usage date information that is the same as the working day information included in the attendance information, and that includes an expense type identifier (for example, a “labor wage”) indicating a labor wage is present in the expense information storage unit 111. Upon determining that the expense information is not present in the expense information storage unit 111, the inspection unit 131 acquires an inspection result indicating that “no application has been submitted for an expense corresponding to the attendance information”.

Regarding whether or not the acquired attendance information is information indicating attendance that falls within the salary range, for example, the inspection unit 131 acquires day-of-the-week information included in the attendance information, and if the day-of-the-week information indicates a day of the week that is not a working day (for example, Saturday, Sunday, or a holiday), the inspection unit 131 judges that the acquired attendance information indicates attendance that does not fall within the salary range. For example, the inspection unit 131 acquires an applicant identifier corresponding to the attendance information, and if the applicant type information paired with the applicant identifier is predetermined information (for example, “a non-regular job”, or “part-time job”), the inspection unit 131 judges that the acquired attendance information indicates attendance that does not fall within the salary range. Note that applicant type information is information that is included in personal information stored in the personal information storage unit 1121.

### (b) Omission of Application for Business Trip Expense

The inspection unit 131 acquires attendance information corresponding to one applicant identifier, from the attendance information storage unit 1122. Next, the inspection unit 131 judges whether or not the acquired attendance information is information that corresponds to a business trip. If the attendance information is information that corresponds to a business trip, the inspection unit 131 judges whether or not expense information that corresponds to one applicant identifier, that includes usage date information that is the same as the working day information included in the attendance information, and that includes an expense type identifier of an expense that is to be applied for a business trip (for example, a “business trip expense” or a “travel transportation expense”) is present in the expense information storage unit 111. Upon determining that such expense information is not present in the expense information storage unit 111, the inspection unit 131 acquires an inspection result indicating that “no application has been submitted for an expense corresponding to a business trip”.

For example, if the attendance information has a business trip flag indicating a business trip, the inspection unit 131 judges that the attendance information is information corresponding to a business trip. Alternatively, for example, when the attendance information does not include start time information or end time information, the inspection unit 131 judges that the attendance information is information corresponding to a business trip. Alternatively, when the attendance information includes a location identifier indicating a business trip destination, the inspection unit 131 judges that the attendance information is information corresponding to a business trip.

### (c) Omission of Application for Overseas Daily Allowance

The inspection unit 131 acquires attendance information corresponding to one applicant identifier, from the attendance information storage unit 1122. Next, the inspection unit 131 judges whether or not the acquired attendance information is information that corresponds to an overseas business trip. If the attendance information is information that corresponds to an overseas business trip, the inspection unit 131 judges whether or not expense information that corresponds to one applicant identifier, that includes usage date information that is the same as the working day information included in the attendance information, and that includes an expense type identifier of an expense that is to be applied for an overseas business trip (for example, an “overseas daily allowance” or an “overseas travel allowance”) is present in the expense information storage unit 111. Upon determining that such expense information is not present in the expense information storage unit 111, the inspection unit 131 acquires an inspection result indicating that “no application has been submitted for an expense corresponding to an overseas business trip”.

For example, if the attendance information has an overseas business trip flag indicating an overseas business trip, the inspection unit 131 judges that the attendance information is information corresponding to an overseas business trip. Alternatively, when the attendance information includes a location identifier indicating an overseas business trip destination, the inspection unit 131 judges that the attendance information is information corresponding to an overseas business trip.

Alternatively, for example, the inspection unit 131 may acquire predetermined amount information for an overseas business trip included in the company regulation information in the company regulation information storage unit 113, compare it with amount information regarding the expense information corresponding thereto. If they do not match, the inspection unit 131 may acquire an inspection result indicating “improper application for overseas daily allowance”.

For example, the inspection unit 131 acquires business activity information corresponding to one applicant identifier, from the business activity information storage unit 1124. Upon determining that the location identifier included in the business activity information is a location identifier corresponding to an overseas business trip, the inspection unit 131 acquires business day information that is included in the business activity information. Next, the inspection unit 131 judges whether or not expense information that corresponds to one applicant identifier, that includes usage date information that is the same as the acquired business day information, and that includes an expense type identifier indicating an expense that is to be applied for an overseas business trip is present in the expense information storage unit 111. Upon determining that such expense information is not present in the expense information storage unit 111, the inspection unit 131 acquires an inspection result indicating that “no application has been submitted for an expense corresponding to an overseas business trip”.

### (14-2) Detection of Omission of Application Using Entry/Exit Information

### (a) Omission of Application for Labor Wage Expense

The inspection unit 131 acquires entry/exit information corresponding to one applicant identifier, from the entry/exit information storage unit 1123. Next, the inspection unit 131 judges whether or not the acquired entry/exit information corresponds to work that does not fall within the salary range. Next, upon determining that the entry/exit information is information corresponding to work that does not fall within the salary range, the inspection unit 131 judges whether or not expense information that corresponds to one applicant identifier, that includes usage date information that is the same as the working day information included in the entry/exit information, and includes an expense type identifier (for example, a “labor wage”) indicating a labor wage is present in the expense information storage unit 111. Upon determining that the expense information is not present in the expense information storage unit 111, the inspection unit 131 acquires an inspection result indicating that “no application has been submitted for an expense corresponding to the entry/exit information”.

Regarding whether or not the acquired entry/exit information is information indicating attendance that falls within the salary range, for example, the inspection unit 131 acquires day-of-the-week information included in the entry/exit information, and if the day-of-the-week information indicates a day of the week that is not a working day (for example, Saturday, Sunday, or a holiday), the inspection unit 131 judges that the acquired entry/exit information indicates attendance that does not fall within the salary range. For example, the inspection unit 131 acquires an applicant identifier corresponding to the entry/exit information, and if the applicant type information paired with the applicant identifier is predetermined information (for example, “a non-regular job”, or “part-time job”), the inspection unit 131 judges that the acquired entry/exit information indicates work that does not fall within the salary range.

### (b) Omission of Application for Business Trip Expense

The inspection unit 131 acquires entry/exit information corresponding to one applicant identifier, from the entry/exit information storage unit 1123. Next, the inspection unit 131 judges whether or not the acquired entry/exit information is information that corresponds to a business trip. If the entry/exit information is information that corresponds to a business trip, the inspection unit 131 judges whether or not expense information that corresponds to one applicant identifier, that includes usage date information that is the same as the working day information included in the entry/exit information, and that includes an expense type identifier of an expense that is to be applied for a business trip (for example, a “business trip expense” or a “travel transportation expense”) is present in the expense information storage unit 111. Upon determining that such expense information is not present in the expense information storage unit 111, the inspection unit 131 acquires an inspection result indicating that “no application has been submitted for an expense corresponding to a business trip”.

Alternatively, for example, when the entry/exit information does not include start time information or end time information, the inspection unit 131 judges that the entry/exit information is information corresponding to a business trip. For example, upon determining that the entry/exit information does not include start time information or end time information, the entry/exit information corresponds to one applicant identifier, and attendance information that includes working day information that is the same as the usage date information is information indicating attendance (not absent), the inspection unit 131 judges that the entry/exit information is information corresponding to a business trip.

### (14-3) Detection of Omission of Application Using Business Activity Information

### (a) Omission of Application for Business Trip Expense

The inspection unit 131 acquires business activity information corresponding to one applicant identifier, from the business activity information storage unit 1124. Next, the inspection unit 131 judges whether or not the acquired business activity information is information that corresponds to a business trip. If the business activity information is information that corresponds to a business trip, the inspection unit 131 judges whether or not expense information that corresponds to one applicant identifier, that includes usage date information that is the same as the business day information included in the business activity information, and that includes an expense type identifier of an expense that is to be applied for a business trip (for example, a “business trip expense” or a “travel transportation expense”) is present in the expense information storage unit 111. Upon determining that such expense information is not present in the expense information storage unit 111, the inspection unit 131 acquires an inspection result indicating that “no application has been submitted for an expense corresponding to a business trip”.

For example, using the location identifier included in the business activity information and a predetermined positional information regarding the company, the inspection unit 131 acquires the distance between the location identified by the location identifier and the company, using map information that is stored in the map information storage unit 1182. For example, upon determining that the distance is equal to or greater than the distance at which a travel expense is incurred, the inspection unit 131 judges that the business activity information is information corresponding to a business trip. Note that information regarding the minimum distance for which a travel expense is incurred is stored in the company regulation information storage unit 113, for example.

Also, for example, the inspection unit 131 judges that business activity information is information corresponding to a business trip if the business activity information includes a location identifier.

Note that the algorithm for determining that business activity information is information corresponding to a business trip is not limited. Business activity information may have a flag indicating whether or not the activity is a business trip.

### (b) Omission of Application for Transportation Expense

The inspection unit 131 acquires one or more location identifiers included in the business activity information corresponding to one applicant identifier, from the business activity information storage unit 1124. Next, using positional information regarding the company, which is stored in advance, and the one or more location identifiers thus acquired, the inspection unit 131 judges whether or not a transportation expense is incurred. Upon determining that a transportation expense is incurred, the inspection unit 131 judges whether or not expense information that includes usage date information that is the same as the business day information included in the business activity information and that includes an expense type identifier indicating a “travel transportation expense” is present in the expense information storage unit 111. Upon determining that such expense information is not present in the expense information storage unit 111, the inspection unit 131 acquires an inspection result indicating that “no application has been submitted for a transportation expense”.

Note that the inspection unit 131 uses, for example, the calculation information stored in the calculation information storage unit 1181 to judge whether or not a transportation expense is incurred. Specifically, for example, the inspection unit 131 provides location information regarding the company and the location identifier to a calculation module that calculates a transportation expense, and judges whether or not information regarding a transportation expense is to be output. Alternatively, for example, using map information, the inspection unit 131 acquires the distance between the positional information regarding the company and the location identifier, and judges whether or not the distance is no less than a threshold value to judge whether or not a transportation expense is incurred. Note that the calculation module is a well-known technology.

### (14-4) Detection of Omission of Application Using Business Vehicle Location Information

### (a) Omission of Application for Business Trip Expense

The inspection unit 131 acquires one or more pieces of business vehicle location information corresponding to one applicant identifier and one piece of usage date information, from the business vehicle location information storage unit 1126. Next, the inspection unit 131 judges whether or not the one or more pieces of business vehicle location information thus acquired are piece of information that correspond to a business trip. If each piece of business vehicle location information is information that corresponds to a business trip, the inspection unit 131 judges whether or not expense information that corresponds to one applicant identifier, that includes usage date information that is the same as the usage date information corresponding to the business vehicle location information, and that includes an expense type identifier of an expense that is to be applied for a business trip (for example, a “business trip expense”) is present in the expense information storage unit 111. Upon determining that such expense information is not present in the expense information storage unit 111, the inspection unit 131 acquires an inspection result indicating that “no application has been submitted for an expense corresponding to a business trip”.

Note that, for example, using each of one or more pieces of business vehicle location information and positional information regarding the company, which is stored in advance, the inspection unit 131 acquires the maximum value of the distance between the position indicated by the business vehicle location information and the company, using the map information stored in the map information storage unit 1182. For example, upon determining that the maximum value of the distance is equal to or greater than the distance at which a travel expense is incurred, the inspection unit 131 judges that the business activity information is information corresponding to a business trip. Note that information regarding the minimum distance for which a travel expense is incurred is stored in the company regulation information storage unit 113, for example.

Alternatively, for example, if a business trip flag that is associated with each of one or more pieces of business vehicle location information is present, the inspection unit 131 judges that the business activity information is information corresponding to a business trip. Note that a business trip flag is a flag indicating a business trip.

The output unit 14 outputs various kinds of information. Examples of various kinds of information include an inspection result, an image inspection result, and a statistical processing result. Here, “output” typically means transmission to an applicant terminal 2, but may mean transmission to another device such as an administrator terminal, accumulation in the expense inspection device 1, displaying on a display device, or the like.

### (15) Receipt Image Inspection Performed by Image Inspection Part 1311

For example, the image inspection part 1311 acquires one or more strings using at least either character recognition processing or machine learning processing (for example, one of the above methods (1) to (3)), and judges whether or not each of the one or more strings thus acquired satisfies a predetermined condition, to acquire an image inspection result. Each of the one or more strings is, for example, payment amount information, a store identifier, a counterparty identifier, a usage date information, a subject, a summary, or payment method information.

Examples of inspections performed by the image inspection part 1311 are (15-1) to (15-9) shown below. For example, the image inspection part 1311 performs one or more inspections of the inspections (15-1) to (15-9) to acquire an image inspection result. Note that (15-1) to (15-9) are examples of receipt image inspection.

### (15-1) Inspection of Discrepancy Between Receipt Image and String in Expense Information

The image inspection part 1311 acquires one or more sets that each consist of a string and a class, from the receipt image included in the expense information accepted by the expense acceptance unit 121. Next, for each set, the inspection unit 131 acquires a string (for example, one of the following: payment amount information, a store identifier, a counterparty identifier, usage date information, subject, subject, and payment method information) that corresponds to the class included in the set and is included in the expense information accepted by the expense acceptance unit 121. Next, for each set, the inspection section 131 compares the string of one class acquired from the receipt image with the string of the same class included in the expense information accepted by the expense acceptance unit 121, to judge whether or not the strings have a predetermined relationship. If the strings do not have the predetermined relationship, the inspection unit 131 acquires an inspection result indicating improperness.

Note that the predefined relationship is a match, but the strings have the relationship when they are similar enough to satisfy a predefined condition (for example, a case in which the degree of similarity is no less than a threshold value, a case in which there only is the difference between “corporation” and “Co. Ltd”, a case in which there only is the difference in notation, etc.).

### (15-2) Inspection of Modification of Amount of Money

### (a) Case of Using Character Recognition Processing

For example, the image inspection part 1311 uses a character recognition technology to acquire a string in the area of the amount of money and a score from a receipt image, and upon determining that the score is low enough to satisfy a predetermined condition, the image inspection part 1311 judges that the amount of money on the receipt has been modified. For example, the image inspection part 1311 acquires all characters in the receipt image using a character recognition technology, detects the character “\” from the group of the characters, and acquires the numeric sequence next to the character “\” as payment amount information.

### (b) Case of Using Machine Learning Processing

For example, the image inspection part 1311 forms a learner that, using one or more receipt images in which the amount of money has been forged by handwriting and one or more receipt images in which the amount of money has not been forged, as pieces of training data, performs learning processing according to a machine learning algorithm, and acquires an inspection result indicating whether or not the amount of money has been forged, using a receipt image as an input.

Next, for example, the image inspection part 1311 performs prediction processing according to a machine learning algorithm using the receipt image accepted by the expense acceptance unit 121 and the learner, to acquire an image inspection result indicating whether or not the amount of money on the receipt image was forged by handwriting.

### (15-3) Inspection of Inappropriateness or the Like Regarding Tax Classification

The image inspection part 1311 acquires two or more strings from the receipt image. Next, the image inspection part 1311 judges whether or not the two or more strings match a predetermined improper pattern. If the two or more strings match the predetermined improper pattern, the image inspection part 1311 acquires an inspection result indicating an improperness.

For example, an improper pattern is a pattern in which the string “gift” is included in the string corresponding to the class “summary” and “10%” is included in the string corresponding to the class “tax classification”. Such an improper pattern corresponds to improperness regarding tax classification. For example, using the acquired strings, upon determining that the string corresponding to the class “summary” includes “gift” and the string corresponding to the class “tax classification” includes “10%”, the image inspection part 1311 acquires an image inspection result indicating “improper ness regarding tax classification”.

### (15-4) Inspection of Incomplete Addressee Name

The image inspection part 1311 acquires one or more strings from the receipt image in association with a class.

Next, upon determining that the string corresponding to the class “addressee name” does not match any of the company names stored in the storage unit 11, the image inspection part 1311 acquires an image inspection result indicating an incomplete addressee name on the receipt. Alternatively, for example, using the acquired strings, upon determining that the string corresponding to the class “addressee name” is an inappropriate string such as “customer” stored in the storage unit 11, the image inspection part 1311 acquires an image inspection result indicating an incomplete addressee name on the receipt.

### (15-5) Inspection of Presence or Absence of Signature on Receipt

For example, using training data that includes one or more receipts on which a signature is present as positive examples, and one or more receipts on which a signature is not present as negative examples, the image inspection part 1311 forms a learner according to a machine learning algorithm. Thereafter, using the accepted receipt image and the learner, the image inspection part 1311 performs prediction processing to acquire information indicating the presence or absence of a signature. Upon determining that a signature is not present, the image inspection part 1311 acquires an image inspection result indicating incompleteness regarding the absence of a signature on the receipt.

### (15-6) Inspection of Unclearness of Receipt Image

### (a) Case of Using Character Recognition Processing (First Unclearness Processing)

The image inspection part 1311 performs first unclearness processing through which, using a character recognition technology, the image inspection part 1311 acquires one or more strings from the receipt image accepted by the expense acceptance unit 121, together with a character recognition score, and judges that the receipt image is unclear if the score is low enough to satisfy a predetermined condition. Note that the technique for performing character recognition, acquiring a string, and outputting a character recognition score (which may be referred to as a likelihood) is a well-known technique.

### (b) Case of Using Machine Learning Processing (Second Unclearness Processing)

The image inspection part 1311 performs learning processing on one or more unclear receipt images and one or more clear receipt images according to a machine learning algorithm, to form a learner. Note that such a learner is a learner that receives a receipt image as an input and acquires a determination result that indicates whether the receipt image is unclear or clear.

Next, using the receipt image accepted by the expense acceptance unit 121 and the learner, the image inspection part 1311 performs prediction processing according to a machine learning algorithm, to acquire an inspection result indicating whether the receipt image is unclear or clear.

### (15-7) Inspection of Payment Method

The image inspection part 1311 acquires payment means information that is a string (for example, “∘∘ pay”) from a receipt image, and judges whether or not the payment means information is the payment means information included in company regulation information, to acquire an image inspection result. Note that company regulation information is present in the company regulation information storage unit 113.

### (15-8) Inspection of Presence or Absence of Square Stamp on Handwritten Receipt

### (a) Case of Using Machine Learning Processing

For example, using one or more handwritten receipt images with a square stamp as positive examples and one or more receipt images without a square stamp as negative examples, the image inspection part 1311 performs learning processing according to a machine learning algorithm, to form a learner. Note that such a learner is a learner that receives a receipt image as an input and outputs a result indicating whether or not a square stamp is present thereon.

Next, using the accepted receipt image and the learner, the image inspection part 1311 performs prediction processing according to a machine learning algorithm, to acquire an image inspection result indicating whether or not a square stamp is present.

### (b) Case of Using Image Recognition Processing

The image inspection part 1311 performs character recognition processing on the accepted receipt image to judge whether or not handwritten characters are present (for example, whether or not the score is no greater than a threshold value or less than a threshold value). Upon determining that handwritten characters are present, the image inspection part 1311 judges, for example, whether or not a square stamp that has pixel values within the range of the color red and has a substantially rectangular outline, through image recognition. Upon determining that a rectangular stamp is not present, the image inspection part 1311 acquires an image inspection result indicating that a square stamp is not present.

### (15-9) Inspection of Time Stamp

The image inspection part 1311 acquires date information indicated by the time stamp included in the accepted receipt image. Note that date information is information that indicates the date when the time stamp was added to the receipt image.

Next, the image inspection part 1311 acquires a receipt issuance date corresponding to the accepted receipt image.

Next, the image inspection part 1311 judges whether or not the date indicated by the acquired date information is later than the receipt issuance date by a predetermined period or longer, and acquires an image inspection result. The predetermined period or more is, for example, “3 days or more” or “4 days or more”.

Note that the image inspection part 1311 typically acquires the receipt issuance date from the receipt image, but may acquire the receipt issuance date that is a string included in the expense information accepted by the expense acceptance unit 121. The technique for adding a time stamp to a receipt image and the technique for acquiring a time stamp included in a receipt image are well-known techniques.

It is preferable that the storage unit 11, the expense information storage unit 111, the applicant group storage unit 112, the company regulation information storage unit 113, the restaurant group storage unit 114, the brothel group storage unit 115, the counterparty group storage unit 116, the credit card usage expense storage unit 117, the transportation means information storage unit 118, the personal information storage unit 1121, the attendance information storage unit 1122, the entry/exit information storage unit 1123, the business activity information storage unit 1124, the credit card statement information storage unit 1125, the business vehicle location information storage unit 1126, the calculation information storage unit 1181, the map information storage unit 1182, and the first storage unit 21 are realized using a non-volatile recording medium, but they may be realized using a volatile recording medium.

There is no limitation on the process in which information is stored in the storage unit 11 or the like. For example, information may be stored in the storage unit 11 or the like via a recording medium, or information transmitted via a communication line or the like may be stored in the storage unit 11 or the like, or information input via an input device may be stored in the storage unit 11 or the like.

The acceptance unit 12, the expense acceptance unit 121, and the first receiving unit 25 typically are realized using a wireless or wired communication means, but may be realized using a broadcast receiving means.

The processing unit 13, the inspection unit 131, the statistical processing unit 132, the image inspection part 1311, and the first processing unit 23 can typically be realized using a processor, a memory, or the like. The processing procedures performed by the processing unit 13 typically are realized using software, and the software is recorded on a recording medium such as a ROM. However, such processing procedures may be realized using hardware (a dedicated circuit). The processor may be an MPU, a CPU, a GPU, or the like, and the type thereof is not limited.

The output unit 14, the result output unit 141, and the first transmitting unit 24 typically are realized using a wireless or wired communication means, but may be realized using a broadcast receiving means.

The first acceptance unit 22 can be realized using a device driver for the input means such as a touch panel or a keyboard, or control software or the like for controlling the menu screen.

The first output unit 26 may be regarded as including or not including an output device such as a display or a speaker. The first output unit 26 can be realized using the driver software of the output device, the driver software of the output device and the output device, or the like.

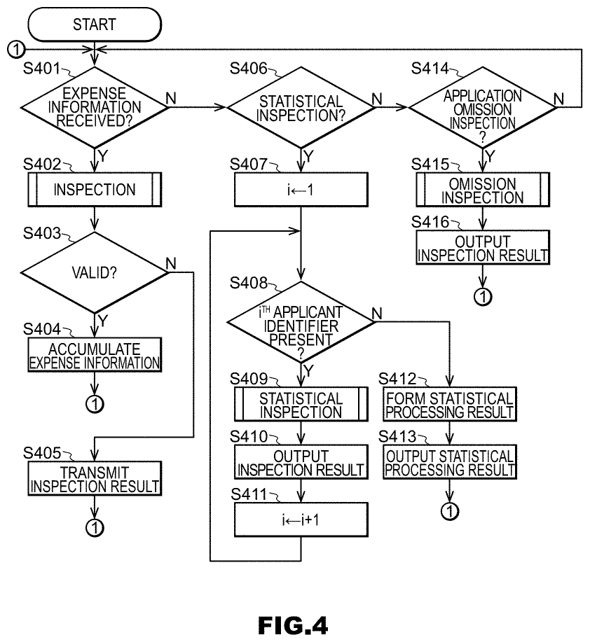

Next, examples of operations of the expense inspection device 1 will be described with reference to the flowchart in FIG. 4.

(Step S401) The expense acceptance unit 121 judges whether or not expense information that is associated with an application identifier has been received from an applicant terminal 2. If expense information has been received, processing proceeds to step S402, and if expense information has not been received, processing proceeds to step S406.

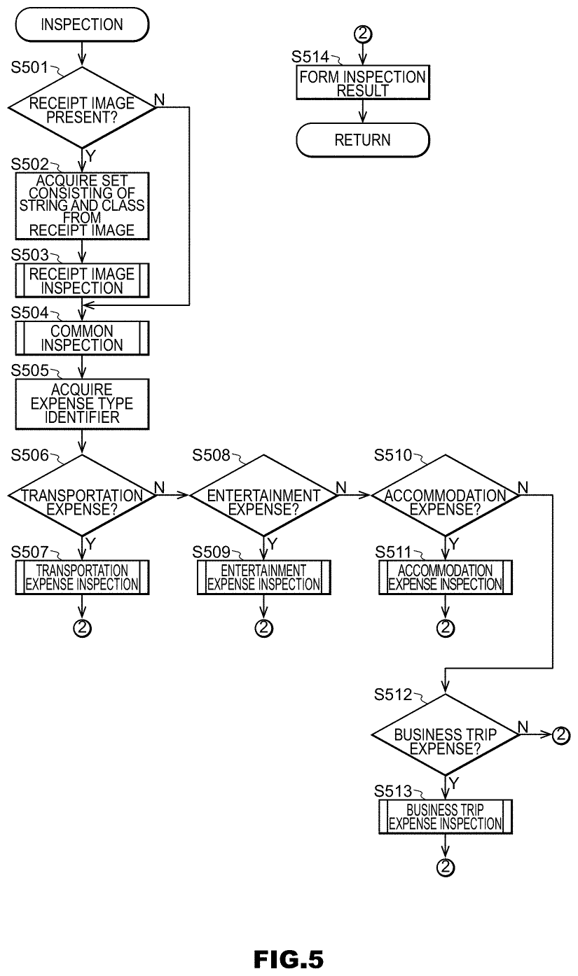

(Step S402) The processing unit 13 performs inspection processing on the expense information received in step S401. Inspection processing is processing that is performed to inspect improperness regarding an expense application. An example of inspection processing will be described with reference to the flowchart in FIG. 5.

(Step S403) The inspection unit 131 judges whether or not the inspection result acquired in step S402 is “valid”. If the result is “valid”, the processing proceeds to step S404, and if the result is not “valid”, the processing proceeds to step S405.

(Step S404) The processing unit 13 or an accumulation unit (not shown) accumulates the expense information received in step S401 in the expense information storage unit 111 in association with the application identifier. Processing returns to step S401. Note that, in step S404, the result output unit 141 may output an inspection result indicating “valid” to the applicant terminal 2 that has transmitted the expense information.

(Step S405) The result output unit 141 transmits the inspection result acquired in step S402 to the applicant terminal 2 that has transmitted the expense information. Processing returns to step S401. Note that, in step S405, the inspection unit 131 may increment the improper application count corresponding to the applicant identifier corresponding to the expense information by one. Also, in step S405, the processing unit 13 or the accumulation unit (not shown) may accumulate the expense information received in step S401 in the expense information storage unit 111 in association with the application identifier.

(Step S406) The processing unit 13 judges whether or not it is the time to perform a statistical inspection. If it is the time to perform a statistical inspection, processing proceeds to step S407, and if it is not the time to perform a statistical inspection, processing proceeds to step S414.

Note that the processing unit 13 acquires the time from a clock (not shown), and if the time is no earlier than a predetermined time, the processing unit judges that it is the time to perform a statistical inspection. Alternatively, if an instruction to perform a statistical inspection has been received, the processing unit 13 judges that it is the time to perform a statistical inspection. A statistical inspection is an inspection regarding improperness, performed using the results of statistical processing performed on expense information. It is preferable that statistical inspections are performed regularly (for example, once a month).

(Step S407) The processing unit 13 substitutes 1 for a counter i.

(Step S408) The processing unit 13 judges whether or not the i^{th} applicant identifier is present in the expense information storage unit 111. If the i^{th} applicant identifier is present, processing proceeds to step S409, and if the i^{th} applicant identifier is not present, processing proceeds to step S412. Whether or not the i^{th} applicant identifier is present is whether or not the i^{th} applicant of the inspection target is present.

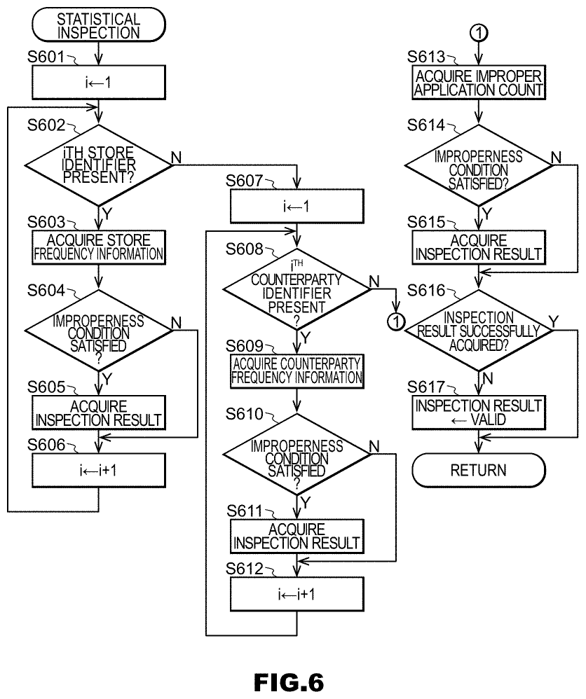

(Step S409) The processing unit 13 performs statistical processing on the expense information corresponding to the i^{th} applicant identifier, and performs an inspection of improperness regarding an expense application, using the statistical processing result. An example of such statistical inspection processing will be described with reference to the flowchart in FIG. 6.

(Step S410) The processing unit 13 outputs the inspection result acquired in step S409, in association with the i^{th} applicant identifier. For example, the processing unit 13 accumulates the inspection result in the storage unit 11 in association with the i^{th} applicant identifier. Alternatively, for example, the processing unit 13 transmits the inspection result associated with the i^{th} applicant identifier to a terminal (not shown).

(Step S411) The processing unit 13 increments the counter i by one. Processing returns to step S408.

(Step S412) The statistical processing unit 132 forms a statistical processing result that is to be output.

(Step S413) The result output unit 141 outputs the statistical processing result formed in step S412. Processing returns to step S401. Note that examples of the output of the statistical processing result include the accumulation of the statistical processing result in the storage unit 11 and the transmission of the statistical processing result to a terminal (not shown).

(Step S414) The processing unit 13 judges whether or not it is the time to perform an application omission inspection. If it is the time to perform an application omission inspection, processing proceeds to step S415, and if it is not the time to perform an application omission inspection, processing returns to step S401.

Note that the processing unit 13 acquires the time from a clock (not shown), and if the time is no earlier than a predetermined time, the processing unit judges that it is the time to perform an application omission inspection. Alternatively, if an instruction to perform an application omission inspection has been received, the processing unit 13 judges that it is the time to perform a statistical inspection. The application omission inspection is an inspection of an omission of an expense application. It is preferable that application omission inspections are performed regularly (for example, once a month).

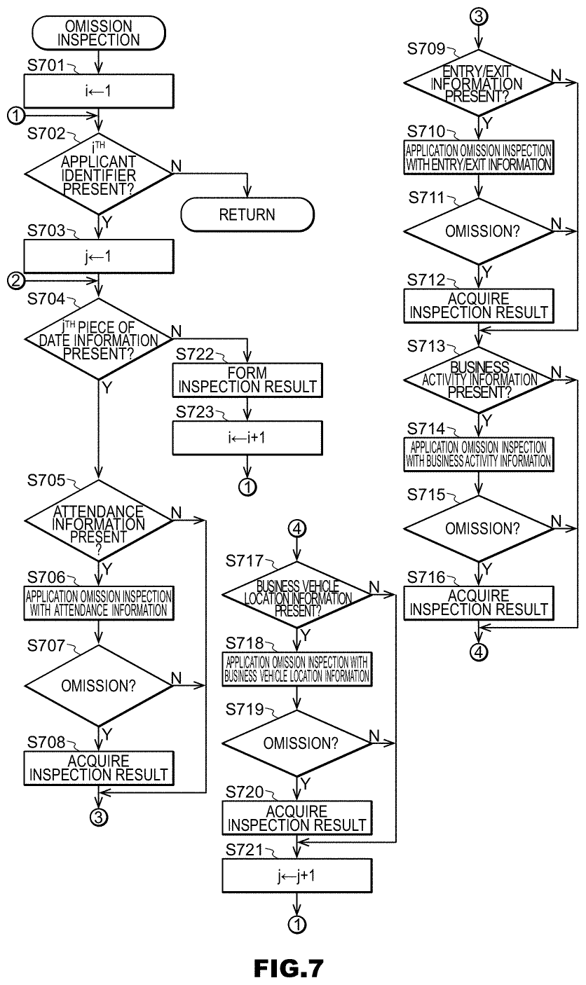

(Step S415) The processing unit 13 performs an expense application omission inspection. An example of omission inspection processing will be described with reference to the flowchart in FIG. 7.

(Step S416) The result output unit 141 outputs an inspection result regarding the omission inspection, acquired in step S415. Processing returns to step S401. Examples of the output of the inspection result here include the accumulation of the inspection result in the storage unit 11, the transmission of the same to the applicant identified by the applicant identifier corresponding to the omission, and the transmission of the same to a terminal (not shown).

Note that, in the flowchart in FIG. 4, processing ends when the power is turned off or an interruption occurs to end the processing.

Next, an example of the inspection processing in step S402 will be described with reference to the flowchart in FIG. 5.

(Step S501) The inspection unit 131 judges whether or not a receipt image is included in the accepted expense information. If a receipt image is included, processing proceeds to step S502, and if a receipt image is not included, processing proceeds to step S505.

(Step S502) The image inspection part 1311 acquires one or more sets that each consist of a string and a class, from the receipt image. Such processing has been described above, and therefore the detailed descriptions thereof will be omitted here.

(Step S503) The image inspection part 1311 performs a receipt image inspection to acquire an inspection result.

Examples of receipt image inspections include one or more inspections of the inspections (15-1) to (15-9) described above.

(Step S504) The inspection unit 131 performs a common inspection to acquire an inspection result. A common inspection is an inspection that does not depend on the expense type identifier (or the subject) of the expense information.

Examples of common inspections include (1-1) (2-1) Inspection of Expenses on a Day other than Working Days, (4-1) Inspection of Receipt Splitting, (5-1) Inspection of Improper Use of Business Vehicle, (6) Inspection using Credit card usage expense Information, (10) Inspection using Counterparty Information, (11-1) Inspection of Duplicate Applications, (11-2) Inspection of Reuse of Receipt, (11-3) Inspection of Submission of Large Number of Expense Applications on Same Day, and (13) Detection of Improperness regarding Expense Application Approver

(Step S505) The inspection unit 131 acquires an expense type identifier from the accepted expense information.

(Step S506) The inspection unit 131 judges whether or not the expense type identifier acquired in step S505 indicates “transportation expense” (or a travel transportation expense). If the expense type identifier indicates “transportation expense”, processing proceeds to step S507, and if the expense type identifier does not indicate “transportation expense”, processing proceeds to step S508.

(Step S507) The inspection unit 131 performs entertainment expense inspection processing to acquire an inspection result. Processing proceeds to step S514.

Transportation expense inspection processing is processing for an inspection that is specific to a transportation expense. Examples of transportation expense inspection processing include (3-1) Inspection of Improperness regarding Transportation Expense (i), (3-2) Inspection of Improperness regarding Transportation Expense (ii), (4-2) Inspection of Taxi Use after Company Drinking Party, (8-1) Inspection of Improperness Regarding Transportation Expense for Train, Bus, or Plane, (8-2) Inspection of Improperness regarding Taxi Fare, and (8-3) Inspection of Overlap with Commuter Pass Section described above.

(Step S508) The inspection unit 131 judges whether or not the expense type identifier acquired in step S505 indicates “entertainment expense (or reception and communication expense)”. If the expense type identifier indicates “entertainment expense”, processing proceeds to step S509, and if the expense type identifier does not indicate “entertainment expense”, processing proceeds to step S510.

(Step S509) The inspection unit 131 performs entertainment expense inspection processing to acquire an inspection result. Processing proceeds to step S514.

Entertainment expense inspection processing is processing for an inspection that is specific to an entertainment expense. Examples of entertainment expense inspection processing include (9-1) Inspection of Improperness regarding Store (Use of Brothel or the like), (9-2) Inspection of Improperness regarding Amount, (9-3) Inspection of Whether or Not Entertainment Expense is for Use of Restaurant, (10) Inspection using Counterparty Information, and (11-4) Inspection of Improperness regarding Expense for After-party.

(Step S510) The inspection unit 131 judges whether or not the expense type identifier acquired in step S505 indicates “accommodation expense”. If the expense type identifier indicates “accommodation expense”, processing proceeds to step S511, and if the expense type identifier does not indicate “accommodation expense”, processing proceeds to step S512.

(Step S511) The inspection unit 131 performs accommodation expense inspection processing to acquire an inspection result. Processing proceeds to step S514.

Accommodation expense inspection processing is processing for an inspection that is specific to an accommodation expense. Examples of accommodation expense inspection processing include (1-3) Inspection of Improperness regarding Accommodation Expense and (2-3) Inspection of Improperness regarding Accommodation Expense.

(Step S512) The inspection unit 131 judges whether or not the expense type identifier acquired in step S505 indicates “business trip expense”. If the expense type identifier indicates “business trip expense”, processing proceeds to step S513, and if the expense type identifier does not indicate “business trip expense”, processing proceeds to step S512.

(Step S513) The inspection unit 131 performs business trip expense inspection processing to acquire an inspection result. Processing proceeds to step S514.

Business trip expense inspection processing is processing for an inspection that is specific to a business trip expense. Examples of business trip expense inspection processing include (1-2) Inspection of Improperness regarding Business Trip Expense and (2-2) Inspection of Improperness regarding Business Trip Expense.

(Step S514) Using the acquired inspection result, the inspection unit 131 forms an inspection result that is to be output. Processing returns to higher-level processing.

For example, if one or more inspection results that indicate an improper application have been acquired, the inspection unit 131 forms an inspection result that includes all of the inspection results that indicate an improper application. If an inspection result that indicates an improper application has not been acquired, the inspection unit 131 forms an inspection result that indicates “valid”.

Next, an example of the statistical inspection processing in step S409 will be described with reference to the flowchart in FIG. 6.

(Step S601) The statistical processing unit 132 substitutes 1 for the counter i.

(Step S602) The statistical processing unit 132 judges whether or not an i^{th} store identifier is included in the store identifiers included in the one or more pieces of expense information that correspond to the applicant identifier of the inspection target (the i^{th} applicant identifier in step S408) and that are stored in the expense information storage unit 111. If the i^{th} store identifier is present, processing proceeds to step S603, and if the i^{th} store identifier is not present, processing proceeds to step S607.

Note that the i^{th} store identifier is the i^{th} store identifier of the stored identifiers that are included in the one or more pieces of expense information corresponding to the applicant identifier of the inspection target and that have been subjected to unique processing. The period to be inspected of the expense information may be determined in advance, or may be the entire period.

(Step S603) The statistical processing unit 132 acquires the number of pieces of expense information that correspond to the applicant identifier of the inspection target and that include the i^{th} store identifier. The statistical processing unit 132 uses the number to acquire store frequency information. Note that store frequency information may have the same value as the number, or the number divided by the period. Store frequency information typically is a value calculated using an increasing function with the number serving as a parameter.

(Step S604) The inspection unit 131 judges whether or not the store frequency information acquired in step S603 is large enough to satisfy a predetermined store frequency condition. If the store frequency condition is satisfied, the processing proceeds to step S605, and if the store frequency condition is not satisfied, processing proceeds to step S606.

(Step S605) The inspection unit 131 acquires an inspection result that indicates that “one store is used too often” and that includes the i^{th} store identifier, in association with the applicant identifier of the inspection target. Note that the inspection unit 131 may increment the improper application count corresponding to the applicant identifier of the inspection target by one.

(Step S606) The statistical processing unit 132 increments the counter i. Processing returns to step S602.

(Step S607) The statistical processing unit 132 substitutes 1 for the counter i.

(Step S608) The statistical processing unit 132 judges whether or not an i^{th} counterparty identifier is included in the store identifiers included in the one or more pieces of expense information that correspond to the applicant identifier of the inspection target and that are stored in the expense information storage unit 111. If the i^{th} counterparty identifier is present, processing proceeds to step S609, and if the i^{th} counterparty identifier is not present, processing proceeds to step S613.

Note that the i^{th} counterparty identifier is the i^{th} counterparty identifier of the counterparty identifiers that are included in the one or more pieces of expense information corresponding to the applicant identifier of the inspection target and that have been subjected to unique processing. The period to be inspected of the expense information may be determined in advance, or may be the entire period.

(Step S609) The statistical processing unit 132 acquires the number of pieces of expense information that correspond to the applicant identifier of the inspection target and that include the i^{th} counterparty identifier. The statistical processing unit 132 uses the number to acquire counterparty frequency information. Note that counterparty frequency information may have the same value as the number, or the number divided by the period. Counterparty frequency information typically is a value calculated using an increasing function with the number serving as a parameter.

(Step S610) The inspection unit 131 judges whether or not the counterparty frequency information acquired in step S603 is large enough to satisfy a predetermined counterparty frequency condition. If the counterparty frequency condition is satisfied, the processing proceeds to step S611, and if the counterparty frequency condition is not satisfied, processing proceeds to step S612.

(Step S611) The inspection unit 131 acquires an inspection result that indicates that “the number of entertainments or the like for one counterparty is too large” and that includes the i^{th} counterparty identifier, in association with the applicant identifier of the inspection target. Note that the inspection unit 131 may increment the improper application count corresponding to the applicant identifier of the inspection target by one.

(Step S612) The statistical processing unit 132 increments the counter i. Processing returns to step S608.

(Step S613) The inspection unit 131 acquires an improper application count corresponding to the applicant identifier of the inspection target, from the personal information storage unit 1121.

(Step S614) The inspection unit 131 judges whether or not the improper application count acquired in step S613 satisfies an improper application count condition. If the improper application count condition is satisfied, the processing proceeds to step S615, and if the improper application count condition is not satisfied, processing proceeds to step S616.

(Step S615) The inspection unit 131 acquires an inspection result indicating that “the improper application count of the applicant is large” in association with the applicant identifier of the inspection target. Note that the inspection result may only include the applicant identifier of the applicant who has a large improper application count.

(Step S616) The inspection unit 131 judges whether or not an inspection result indicating an improper application has been acquired as a result of the statistical inspection. If such an inspection result has been acquired, processing returns to higher-level processing, and if such an inspection result has not been acquired, processing proceeds to step S617.

(Step S617) The inspection unit 131 substitutes “valid” for the variable “inspection result”. Processing returns to higher-level processing.

Next, an example of the omission inspection processing in step S415 will be described with reference to the flowchart in FIG. 7.

(Step S701) The inspection unit 131 substitutes 1 for a counter i. The counter i is the counter for the inspection target applicant.

(Step S702) The inspection unit 131 judges whether or not the i^{th} applicant identifier is present in the storage unit 11. If the i^{th} applicant identifier is present, processing proceeds to step S703, and if the i^{th} applicant identifier is not present, processing returns to higher-level processing. The i^{th} applicant identifier is the identifier of the i^{th} inspection target applicant.

(Step S703) The inspection unit 131 substitutes 1 for a counter j. The counter j is a counter for the inspection target day.

(Step S704) The inspection unit 131 judges whether or not date information indicating the j^{th} inspection target day is present. If date information indicating the j^{th} day is present, processing proceeds to step S705, and if not, processing proceeds to step S722. It is assumed that the date on which an omission inspection is to be performed is predetermined and information specifying the date on which an omission inspection is to be performed is stored in a buffer (not shown).

(Step S705) The inspection unit 131 judges whether or not attendance information that corresponds to the i^{th} applicant identifier and includes working day information that is the same as the date information indicating the j^{th} day is present in the attendance information storage unit 1122. If such information is present, processing proceeds to step S706, and if not, processing proceeds to step S709.

(Step S706) The inspection unit 131 acquires attendance information that corresponds to the i^{th} applicant identifier and includes working day information that is the same as the date information indicating the j^{th} day, from the attendance information storage unit 1122. Using the acquired attendance information, the inspection unit 131 performs an inspection of an omission of an expense application. Examples of such an inspection include the processing described in “(14-1) Detection of Omission of Application using Attendance Information”.

(Step S707) The inspection unit 131 judges whether or not there is an omission, as a result of the inspection in step S706. If there is an omission, processing proceeds to step S708, and if there is no omission, processing proceeds to step S709.

(Step S708) The inspection unit 131 acquires an inspection result indicating the presence of an omission and the content of the omission, in association with the i^{th} applicant identifier and the j^{th} piece of date information.

(Step S709) The inspection unit 131 judges whether or not entry/exit information that corresponds to the i^{th} applicant identifier and includes working day information that is the same as the date information indicating the j^{th} day is present in the entry/exit information storage unit 1123. If such information is present, processing proceeds to step S710, and if not, processing proceeds to step S713.

(Step S710) The inspection unit 131 acquires the entry/exit information that corresponds to the i^{th} applicant identifier and includes working day information that is the same as the date information indicating the j^{th} day, from the entry/exit information storage unit 1123. Using the acquired entry/exit information, the inspection unit 131 performs an inspection of an omission of an expense application. Examples of such an inspection include the processing described in “(14-2) Detection of Omission of Application using Entry/Exit Information”.

(Step S711) The inspection unit 131 judges whether or not there is an omission, as a result of the inspection in step S710. If there is an omission, processing proceeds to step S712, and if there is no omission, processing proceeds to step S713.

(Step S712) The inspection unit 131 acquires an inspection result indicating the presence of an omission and the content of the omission, in association with the i^{th} applicant identifier and the j^{th} piece of date information.

(Step S713) The inspection unit 131 judges whether or not business activity information that corresponds to the i^{th} applicant identifier and includes working day information that is the same as the date information indicating the j^{th} day is present in the business activity information storage unit 1124. If such information is present, processing proceeds to step S714, and if not, processing proceeds to step S717.

(Step S714) The inspection unit 131 acquires business activity information that corresponds to the i^{th} applicant identifier and includes working day information that is the same as the date information indicating the j^{th} day, from the business activity information storage unit 1124. Using the acquired business activity information, the inspection unit 131 performs an inspection of an omission of an expense application. Examples of such an inspection include the processing described in “(14-3) Detection of Omission of Application using Business Activity Information”.

(Step S715) The inspection unit 131 judges whether or not there is an omission, as a result of the inspection in step S714. If there is an omission, processing proceeds to step S716, and if there is no omission, processing proceeds to step S717.

(Step S716) The inspection unit 131 acquires an inspection result indicating the presence of an omission and the content of the omission, in association with the i^{th} applicant identifier and the j^{th} piece of date information.

(Step S717) The inspection unit 131 judges whether or not business vehicle location information that corresponds to the i^{th} applicant identifier and includes working day information that is the same as the date information indicating the j^{th} day is present in the business vehicle location information storage unit 1126. If such information is present, processing proceeds to step S718, and if not, processing proceeds to step S721.

(Step S718) The inspection unit 131 acquires business vehicle location information that corresponds to the i^{th} applicant identifier and includes working day information that is the same as the date information indicating the j^{th} day, from the business vehicle location information storage unit 1126. Using one or more pieces of business vehicle location information thus acquired, the inspection unit 131 performs an inspection of an omission of an expense application. Examples of such an inspection include the processing described in “(14-4) Detection of Omission of Application using Business Vehicle Location Information”.

(Step S719) The inspection unit 131 judges whether or not there is an omission, as a result of the inspection in step S718. If there is an omission, processing proceeds to step S720, and if there is no omission, processing proceeds to step S721.

(Step S720) The inspection unit 131 acquires an inspection result indicating the presence of an omission and the content of the omission, in association with the i^{th} applicant identifier and the j^{th} piece of date information.

(Step S721) The inspection unit 131 increments the counter j by one. Processing returns to step S704.

(Step S722) The inspection unit 131 forms an inspection result corresponding to the i^{th} applicant identifier. For example, the inspection unit 131 temporarily accumulates the inspection result in association with the i^{th} applicant identifier. The inspection results include one or more omission inspection results, for example. If there is no omission, the inspection result is information indicating “no omission”.

(Step S723) The inspection unit 131 increments the counter i by one. Processing returns to step S702.

Next, operations of each applicant terminal 2 will be described. The first acceptance unit 22 of the applicant terminal 2 accepts expense information input by a user. Next, the first processing unit 23 reads out an applicant identifier stored in the first storage unit 21. Thereafter, the first processing unit 23 forms transmission information that includes the accepted expense information and the read-out applicant identifier. Next, the first transmitting unit 24 transmits the transmission information that includes the expense information and the applicant identifier to the expense inspection device 1.

Next, the first receiving unit 25 receives an inspection result from the expense inspection device 1. The first processing unit 23 converts the received inspection result into a structure that is to be output. The first output unit 26 outputs the inspection result.

### SPECIFIC EXAMPLES OF STATISTICAL PROCESSING RESULTS

Hereinafter, examples of statistical processing results that are acquired by the statistical processing unit 132 and are output by the result output unit 141 of the expense inspection device 1 according to the present embodiment.

### Specific Example 1

It is assumed that the statistical processing unit 132 has performed, for each applicant, statistical processing, on expense information of the applicant for a predetermined period (for example, one month in December 2019), where the expense information is stored in the expense information storage unit 111, and has acquired store frequency information for each applicant identifier and each store identifier. It is also assumed that the statistical processing unit 132 has acquired the number of pieces of expense information for each applicant identifier.

It is also assumed that the statistical processing unit 132 has acquired a statistical processing result formed by plotting store frequency information for each applicant identifier and each store identifier on a graph with store frequency information on the vertical axis and the number of pieces of expense information of each applicant identifier on the horizontal axis.

It is also assumed that the statistical processing unit 132 judges that the risk is high if the store frequency condition “store frequency information>=3” in the storage unit 11 is satisfied. It can be said that high risk means improperness. The statistical processing unit 132 acquires the applicant identifier of the applicant judged as being at high risk, the store identifier of the store used, and store frequency information.

Thereafter, the statistical processing unit 132 forms statistical processing results that are to be output, as a result of the above-described processing.

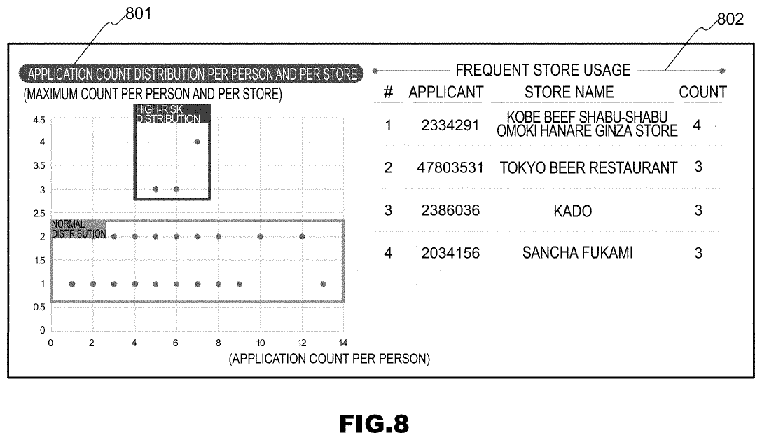

Next, the result output unit 141 outputs the statistical processing results (801, 802). An example of such an output is shown in FIG. 8.

In FIG. 8, 801 is a statistical processing result in which store frequency information is plotted on a graph. The vertical axis of 801 indicates the maximum count per person and per store (store frequency information). The horizontal axis of 801 indicates the number of applications per person.

802 is a table that includes records that each include an applicant identifier, (an applicant), a store name, and store frequency information (a count) corresponding to a piece of store frequency information judged as being at high risk.

### Specific Example 2

Specific example 2 is an example of acquiring information when there is a time stamp even though the person is on a business trip.

For example, for each applicant identifier, if attendance information indicates a business trip, or expense information for a business trip expense or a transportation expense has been submitted for application, the statistical processing unit 132 judges that the day corresponding to the working day information included in the attendance information or the usage date information included in the expense information is the day on which a business trip was made.

Next, regarding entry/exit information that includes working day information that is the same as the working day information included in the attendance information or the usage date information included in the expense information, the statistical processing unit 132 acquires the frequency with which the work start time and the work end time are present (there is a time stamp) (for example, the number of times in a month). Such information indicates the frequency with which time stamps were pressed during a business trip.

Alternatively, for example, for each applicant identifier, the statistical processing unit 132 acquires an average value of the difference between the working time indicated by each of the pieces of attendance information for one month and the working time indicated by the entry/exit information that includes working day information that is the same as the working day information included in the piece of attendance information. Such information indicates the difference between attendance information and the time stamps.

Thereafter, the statistical processing unit 132 forms statistical processing results represented by a graph in which dots corresponding to the applicant identifiers are plotted, on the graph with the horizontal axis indicating the frequency with which time stamps were pressed during a business trip and the vertical axis indicating the difference between attendance information and the time stamps, for each application identifier.

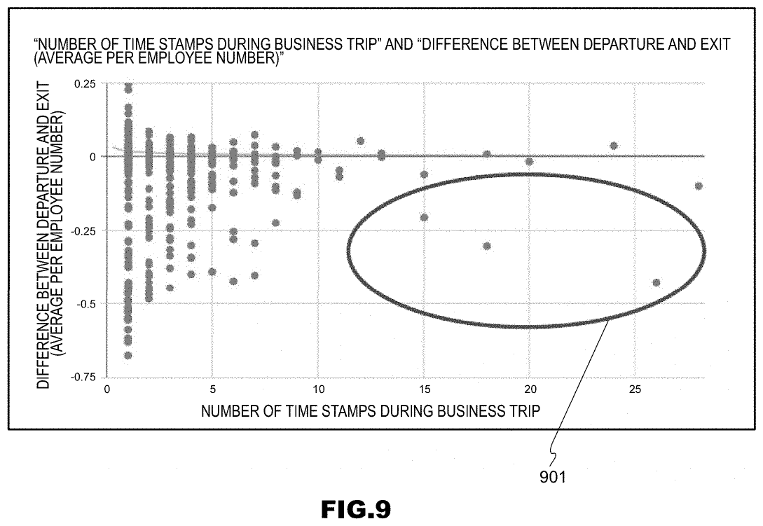

Next, the result output unit 141 outputs the statistical processing results. An example of such an output is shown in FIG. 9. In FIG. 9, the applicants corresponding to the dots in an area 901 are applicants that are likely to have submitted improper applications.

As described above, according to the present embodiment, it is possible to appropriately perform an inspection of an inappropriate expense application, using external information or expense information other than the expense information of the submitted application.

In addition, according to the present embodiment, it is possible to appropriately perform an inspection of an inappropriate expense application, using applicant information.

In addition, according to the present embodiment, it is possible to appropriately perform an inspection of an inappropriate expense application, using the attendance information of the applicant.

In addition, according to the present embodiment, it is possible to appropriately perform an inspection of an inappropriate expense application, using the entry/exit information of applicant.

In addition, according to the present embodiment, it is possible to appropriately perform an inspection of an inappropriate expense application, using the business activity information of applicant.

In addition, according to the present embodiment, it is possible to appropriately perform an inspection of an inappropriate expense application, using the credit card statement information of the applicant.

In addition, according to the present embodiment, it is possible to appropriately perform an inspection of an inappropriate expense application, using the business vehicle location information of the applicant.

In addition, according to the present embodiment, it is possible to appropriately perform an inspection of an inappropriate expense application, using information regarding the credit cards of the applicant.

In addition, according to the present embodiment, it is possible to appropriately perform an inspection of an inappropriate expense application, using company regulation information.

In addition, according to the present embodiment, it is possible to appropriately perform an inspection of an inappropriate expense application, using transportation means information.

In addition, according to the present embodiment, it is possible to appropriately perform an inspection of an inappropriate expense application, using a store group.

In addition, according to the present embodiment, it is possible to appropriately detect inappropriate spending for an inappropriate counterparty.

In addition, according to the present embodiment, it is possible to appropriately detect inappropriate travel expenses, inappropriate transportation expenses, duplicate applications, reuse of receipts, improper accommodation expenses, improper after-party expenses, and the like.

In addition, according to the present embodiment, it is possible to appropriately perform an inspection of an inappropriate expense application, using statistical processing results that are based on two or more pieces of expense information.

In addition, according to the present embodiment, it is possible to detect that a specific store is used frequently.

In addition, according to the present embodiment, it is possible to detect that the frequency of spending for a specific counterparty is high.

In addition, according to the present embodiment, it is possible to detect that a specific person has often submitted improper applications.

In addition, according to the present embodiment, it is possible to detect that the approver of an expense application does not satisfy the requirements.

In addition, according to the present embodiment, it is possible to detect an omission of an expense application.

In addition, according to the present embodiment, it is possible to appropriately perform an inspection of a receipt image.

In addition, according to the present embodiment, it is possible to appropriately perform an inspection of descriptions on a receipt image.

In addition, according to the present embodiment, it is possible to perform an inspection of a flawed time stamp on a receipt image.

In addition, according to the present embodiment, it is possible to inspect an unclear receipt image.

In addition, according to the present embodiment, it is possible to inspect inappropriate payment means.

In addition, according to the present embodiment, it is possible to perform an inspect regarding forgery of the amount of expense by handwriting.

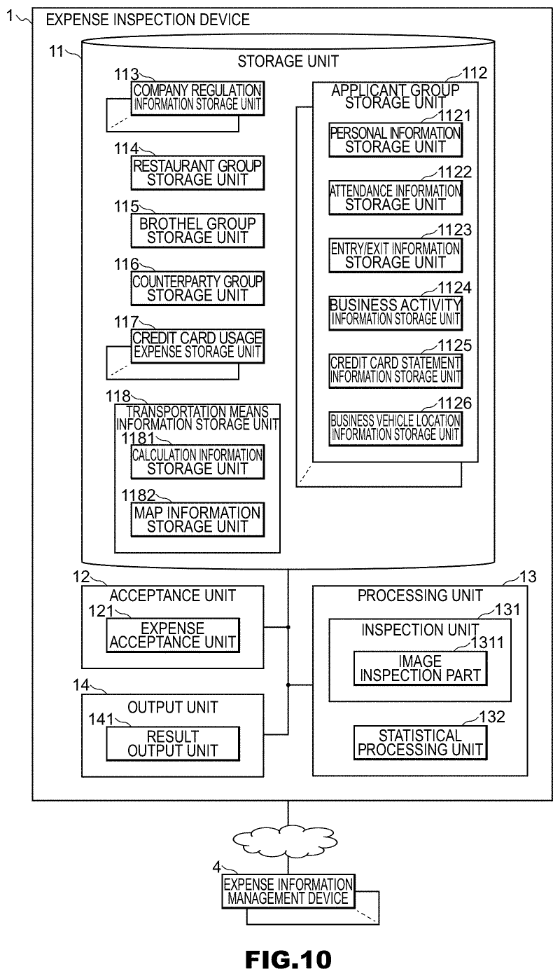

It is preferable that the expense inspection device 1 according to the present invention functions as a device that receives expense information from each of one or more external expense management devices 4, inspects the expense information, and transmits the inspection result to the expense management devices. In such a case, the expense inspection device 1 has the structure shown in FIG. 10, for example. That is to say, in such a case, the applicant group storage unit 112 the company regulation information storage unit 113, the credit card usage expense storage unit 117, the personal information storage unit 1121, the attendance information storage unit 1122, the entry/exit information storage unit 1123, the business activity information storage unit 1124, the credit card statement information storage unit 1125, and the business vehicle location information storage unit 1126 of the expense inspection device 1 are present for each organization identifier. That is to say, an application group, company regulation information, credit card usage expense information, personal information, attendance information, entry/exit information, business activity information, credit card statement information, and business vehicle location information are associated with an organization identifier.

The pieces of expense information received by the expense inspection device 1 respectively from the expense management devices 4 are associated with organization identifiers. If the expense inspection device 1 receives expense information from an expense management device 4, the inspection unit 131 performs an inspection using the applicant group or the like associated with the organization identifier corresponding to the expense information, to acquire an inspection result. The result output unit 141 transmits the inspection result to the expense management device 4. Note that an organization identifier is information that identifies an organization, such as company name or a company ID. An organization is, for example, a company, a group, or a department.

A expense management device 4 that has received expense information from an applicant terminal 2 transmits the expense information to the expense inspection device 1 to inspect the expense information. Thereafter, in response to the transmission of the expense information, the expense management device 4 receives an inspection result from the expense inspection device 1. The expense management device 4 accumulates the expense information only when the inspection result is valid. If the inspection result indicates improperness, the expense management device 4 transmits the inspection result to the applicant terminal 2.

With the above system configuration that includes the expense inspection device 1 and one or more expense management devices 4, the expense inspection device 1 can function as an expense information inspection server. Also, the expense management device 4 can acquire an expense inspection function by using the expense inspection device 1 in addition to the conventional expense information management function.

Also, the expense inspection device 1 can perform the above-described statistical processing by receiving two or more pieces of expense information from one or more expense management devices 4, or by including an expense information storage unit 111 for each organization.

The processing according to the present embodiment may be realized using software. This software may be distributed through software downloading or the like. Also, this software may be recorded on a recording medium such as a CD-ROM and distributed. Note that the same applies to the other embodiments in the present description. The software that realizes the expense inspection device 1 in the present embodiment is the program described below. That is to say, the program is a program that enables a computer to function as: an expense acceptance unit that accepts expense information that specifies details of an application for an expense; an inspection unit that inspects improperness regarding the expense information accepted by the expense acceptance unit, using external information other than expense information, or expense information other than the expense information accepted by the expense acceptance unit, to acquire an inspection result; and a result output unit that outputs the inspection result acquired by the inspection unit.

### Second Embodiment

The present embodiment describes an information system that is provided with an expense management device that includes a groupware technology for realizing appropriate expense application procedures.

The present embodiment describes an information system that is provided with an expense management device that performs contact processing to communicate with the applicant if the expense management device acquires an inspection result indicating improperness regarding the accepted expense information and the inspection result satisfies a predetermined condition. For example, contact processing is performed by writing the inspection result on a web page, by sending a URI that is used to access a page that contains the inspection result, by transmitting the inspection result, or the like.

Also, the present embodiment describes an information system that is provided with an expense management device that performs contact processing to communicate with an administrator. Note that the administrator is a person who manages expense applications, and is a person in charge of accounting, accounting manager, a supervisor of the applicant, or the like.

Also, the present embodiment describes an information system that is provided with an expense management device that accepts a response from the applicant.

Also, the present embodiment describes an information system that is provided with an expense management device that performs post-processing when a response from the applicant satisfies a condition.

Furthermore, the present invention describes an information system that is provided with an expense management device that manages a response deadline and performs appropriate non-response processing when no response is accepted by the response deadline.

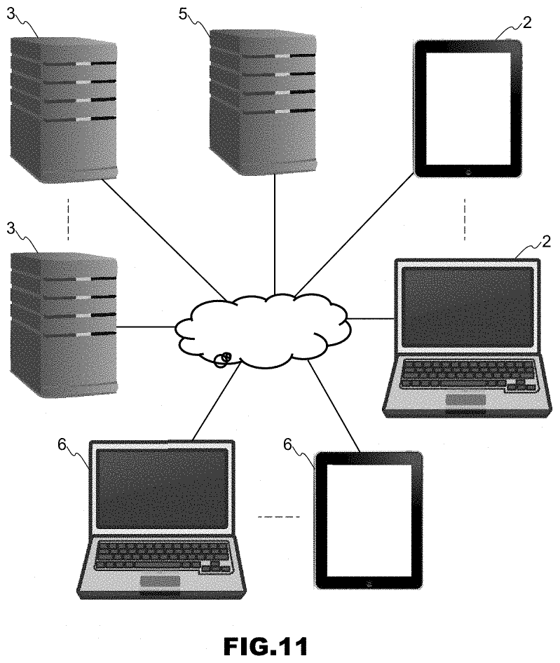

FIG. 11 is a conceptual diagram for an information system B according to the present embodiment. The information system B includes an expense management device 5, one or more applicant terminals 2, one or more administrator terminals 6, and one or more external servers 3. Note that one of the external servers 3 may be the expense inspection device 1.

The expense management device 5 acquires an inspection result corresponding to expense information that has been submitted, and performs contact processing according to the inspection result. Contact processing is performed to communicate with the applicant or communicate with the administrator, for example.

The expense management device 5 may have various functions of the expense inspection device 1 and inspect expense information by itself to acquire an inspection result. The expense management device 5 may transmit the accepted expense information to the expense inspection device 1 and receive an inspection result from the expense inspection device 1. In such a case, the expense management device 5 may be the above-described expense management device 4.

The expense management device 5 is typically a so-called server, such as a cloud server, an ASP server, or the like. Note that the type of the expense management device 5 is not limited.

Each administrator terminal 6 is a terminal of a person who manages expense applications. Note that the person who manages expense applications is, for example, a person in charge of accounting, accounting manager, a supervisor of the applicant, or the like. Each administrator terminal 6 is, for example, a so-called personal computer, a tablet terminal, a smart phone, or the like, and the type thereof is not limited.

The expense management device 5, the applicant terminals 2, the administrator terminals 6, and the external servers 3 are typically capable of communicating with each other via a network such as the Internet or a dedicated line.

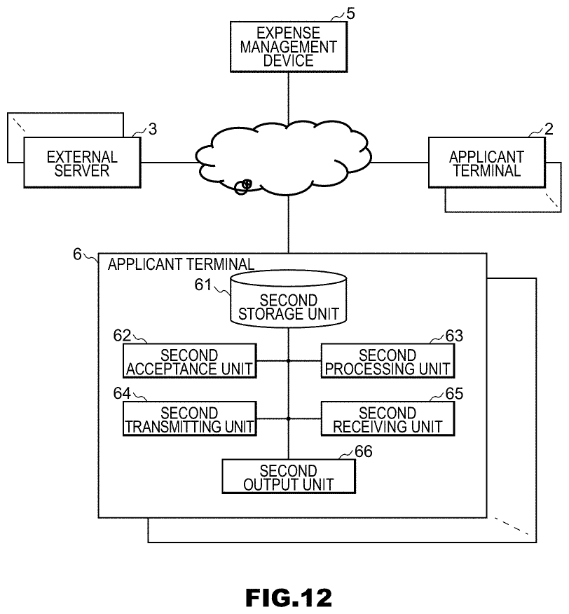

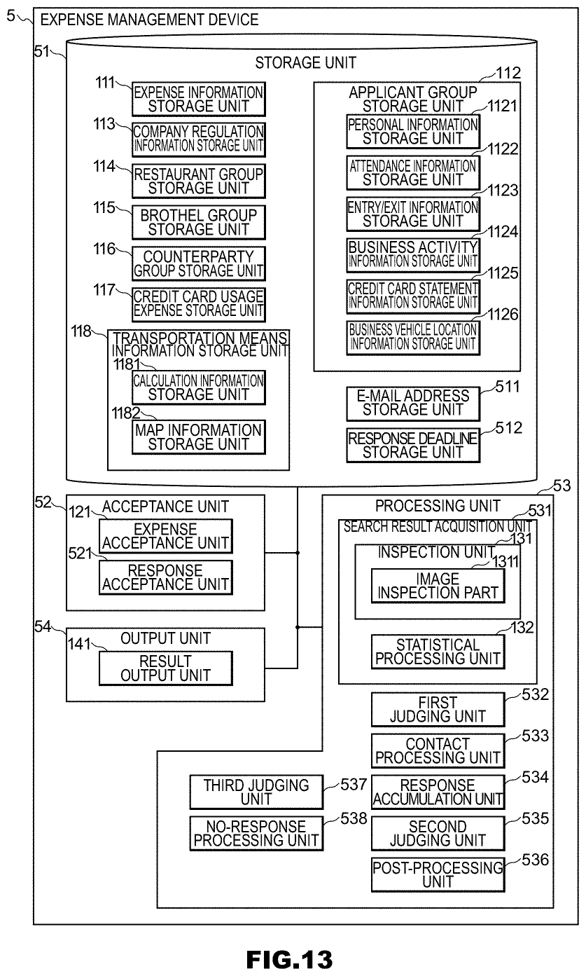

FIG. 12 is a block diagram for the information system B according to the present embodiment. FIG. 13 is a block diagram for the expense management device 5 included in the information system B. FIG. 13 is a block diagram for the expense management device 5 according to the present embodiment.

The expense management device 5 includes a storage unit 51, an acceptance unit 52, a processing unit 53, and an output unit 54. The storage unit 51 includes, for example, an expense information storage unit 111, an applicant group storage unit 112, a company regulation information storage unit 113, a restaurant group storage unit 114, a brothel group storage unit 115, a counterparty group storage unit 116, a credit card usage expense storage unit 117, a transportation means information storage unit 118, an e-mail address storage unit 511, and a response deadline storage unit 512. The acceptance unit 52 includes an expense acceptance unit 121 and a response receiving unit 521. The processing unit 53 includes an inspection result acquisition unit 531, a first judging unit 532, a contact processing unit 533, a response accumulation unit 534, a second judging unit 535, a post-processing unit 536, a third judging unit 537, and a no-response processing unit 538. The inspection result acquisition unit 531 includes, for example, an inspection unit 131 and a statistical processing unit 132. The inspection unit 131 includes an image inspection part 1311. The output unit 54 includes a result output unit 141.

Note that some or all of the constituent elements that constitute the storage unit 51 of the expense management device 5 may be included in one or more external servers 3.

Each administrator terminal 6 includes a second storage unit 61, a second acceptance unit 62, a second processing unit 63, a second transmitting unit 64, a second receiving unit 65, and a second output unit 66.

The storage unit 51 of the expense management device 5 stores various pieces of information. Examples of the various pieces of information include an e-mail address and a response deadline. The various pieces of information are, for example, information to be stored in the storage unit 11.

The e-mail address storage unit 511 included in the storage unit 51 stores the e-mail addresses of one or more administrators. The e-mail address of each administrator may or may not be associated with an applicant identifier. If the administrator is a person in charge of accounting, for example, the e-mail address is not associated with an applicant identifier. In contrast, if the administrator is a supervisor of the applicant, the e-mail address is associated with the applicant identifier.

The response deadline storage unit 512 stores a response deadline. The response deadline may be the number of days from the notification to the applicant, the number of days from the date of application, the number of days from the day on which expenses were used, a predetermined day (for example, “the end of the month” or “the 20^{th} of every month”), the number of days for each inspection result, the number of days for each expense type identifier, or the number of days for each inspection detail identifier. The individual number of days is typically the number of days from the notification to the applicant, but may be the number of days from the date of application or the number of days from the day on which the expense was spent. When the response deadline is the number of days for each inspection result, the response deadline is associated with the response deadline.

The response receiving unit 521 receives response information from an applicant terminal 2, in association with an applicant identifier. The response receiving unit 521 receives response information in association with an inspection result identifier that identifies the inspection result, for example. An inspection result identifier is information that identifies an inspection result, and is an ID, for example. An inspection result identifier may be the same as an expense information identifier.

Response information is information regarding a response to an inspection result. Response information typically is information regarding a response to an inspection result when an application has been judged as being improper. Response information is information that indicates reasons for submitting an expense application. Response information is, for example, a string that indicates reasons for submitting an expense application. Response information is, for example, corrected expense information. response information is, for example, corrected expense information and information that indicates reasons for submitting an expense application or information that indicates a correction has been made. The content, data structure, and so on of response information are not limited. Response information is, for example, information input into a predetermined form screen, and includes one or more items.

The inspection result acquisition unit 531 acquires an inspection result that is the result of the inspection of improperness regarding the expense information accepted by the expense acceptance unit 121. For example, the inspection result acquisition unit 531 accumulates the inspection result in association with the expense information.

For example, the inspection result acquisition unit 531 includes the inspection unit 131, and performs inspection processing on the expense information accepted by the expense acceptance unit 121, to acquire an inspection result. The processing by the inspection unit 131 has been described above, and therefore the descriptions thereof will be omitted here.

For example, the inspection result acquisition unit 531 transmits the expense information accepted by the expense acceptance unit 121 to the external expense inspection device 1, and receives an inspection result from the expense inspection device 1. In such a case, the expense inspection device 1 is an example of an external server 3.

It is preferable that the inspection unit 531 inspects improperness regarding the expense information accepted by the expense acceptance unit 121, using external information other than expense information, or expense information other than the expense information accepted by the expense acceptance unit 121, to acquire an inspection result. In such a case, the inspection result acquisition unit 531 includes the inspection unit 131.

The inspection result acquisition unit 531 may use a statistical processing result acquired by the statistical processing unit 132, to acquire an inspection result.

The first judging unit 532 judges whether or not the inspection result acquired by the inspection result acquisition unit 531 satisfies a predetermined first condition. The first condition is, for example, “improper”, “at risk”, “at high risk”, “store frequency information>=threshold value”, “shop frequency information>threshold value”, “entertainment frequency information>=threshold value”, “entertainment frequency information>threshold value”, or “improper application count>=threshold value”. The first condition typically is stored in the storage unit 51.

Upon determining that the first judging unit 532 judging that the first condition is satisfied, the contact processing unit 533 performs predetermined contact processing. Contact processing is processing performed to inform the applicant of the expense information of the inspection result. Contact processing is, for example, accumulation processing, which will be described later, first transmission processing, which will be described later, second transmission processing, which will be described later, third transmission processing, which will be described later, and fourth transmission processing, which will be described later.

Note that the contact processing unit 533 may perform contact processing even when the inspection result does not satisfy the first condition (when the inspection result is “valid”).

The contact processing unit 533 performs accumulation processing. That is to say, the contact processing unit 533 accumulates the inspection result acquired by the inspection result acquisition unit 531 in association with the applicant identifier corresponding to the expense information accepted by the expense acceptance unit 121. It is preferable that such an inspection result is a detailed inspection result, and includes, for example, an expense information identifier, an applicant identifier, an expense type identifier, amount information, an inspection detail identifier, an application date, and so on. Note that the accumulation location where the inspection result is to be accumulated is not limited. For example, the accumulation location is the storage unit 51 or an external server 3.

The contact processing unit 533 performs first transmission processing. That is to say, the contact processing unit 533 acquires a URI that is used to access inspection results accumulated through accumulation processing. Also, the contact processing unit 533 acquires the applicant identifier corresponding to the expense information accepted by the expense acceptance unit 121. Also, the contact processing unit 533 acquires the e-mail address of the applicant paired with the applicant identifier, from the personal information storage unit 1121 that stores one or more pieces of personal information each including an applicant identifier and an e-mail address. Next, the contact processing unit 533 transmits the acquired URI to the destination indicated by the e-mail address. Note that the URI is a URL or a URN. The personal information storage unit 1121 may be included in an external server 3.

The contact processing unit 533 performs second transmission processing. That is to say, the contact processing unit 533 acquires a URI that is used to access inspection results accumulated through accumulation processing, and transmits the URI to the administrator, using the e-mail address of the administrator. For example, the contact processing unit 533 reads out the e-mail address of the administrator from the e-mail address storage unit 511 and transmits the acquired URI to the e-mail address. For example, the contact processing unit 533 acquires the applicant identifier corresponding to the expense information, reads out one or more e-mail addresses paired with the applicant identifier from the e-mail address storage unit 511, and transmits the acquired URI to the e-mail addresses. Note that the contact processing unit 533 may transmit the URI to both the person in the accounting department and the supervisor.

The contact processing unit 533 performs third transmission processing. That is to say, the contact processing unit 533 acquires the applicant identifier corresponding to the expense information accepted by the expense acceptance unit 121, acquires the e-mail address paired with the applicant identifier from the personal information storage unit 1121 that stores one or more pieces of personal information each including an applicant identifier and an e-mail address, and transmits the inspection result to the applicant at the e-mail address of the applicant.

The contact processing unit 533 performs fourth transmission processing. That is to say, the contact processing unit 533 transmits the inspection result to the administrator, using the e-mail address of the administrator. For example, the contact processing unit 533 reads out the e-mail address of the administrator from the e-mail address storage unit 511 and transmits the acquired inspection result to the e-mail address. For example, the contact processing unit 533 acquires the applicant identifier corresponding to the expense information, reads out one or more e-mail addresses paired with the applicant identifier from the e-mail address storage unit 511, and transmits the acquired inspection result to the e-mail addresses. Note that the contact processing unit 533 may transmit the inspection result to both the person in the accounting department and the supervisor.

The response accumulation unit 534 accumulates the response information received by the response receiving unit 521, in association with the inspection result corresponding thereto. For example, the response accumulation unit 534 accumulates the response information received by the response receiving unit 521, in association with the inspection result identifier received in pair with the response information. The response accumulation unit 534 typically accumulates the response information in association with the applicant identifier as well. The accumulation location where response information is to be accumulated is not limited. For example, the response accumulation unit 534 accumulates response information in the storage unit 51 or an external server 3. It is preferable that the response accumulation unit 534 accumulates receiving date on which the response information was received, together with the response information.

It is preferable that the response accumulation unit 534 acquires date information regarding today from a clock (not shown), acquires the response deadline from the response deadline storage unit 512, and upon judging that today is later than the response deadline, using the date information and the response deadline, the response accumulation unit 534 does not accumulate the response information. Note that, even if the response deadline has passed, response information may be accumulated and the processing unit 53 may transmit an error message indicating that “the response deadline has passed” to the applicant terminal 2.

The second judging unit 535 judges whether or not the response information satisfies a predetermined second condition. The second condition typically is a condition indicating that response information is appropriate. The second condition is, for example, that the response information has necessary items and that the number of characters included in the response information is no less than a threshold value. If the response information is corrected expense information, the second condition is that the result of the second inspection is valid. In such a case, the second judging unit 535 instructs the inspection result acquisition unit 531 to acquire the inspection result, and judges whether or not the acquired inspection result is valid. Note that the second condition is stored in the storage unit 51.

The post-processing unit 536 performs post-processing when the second judging unit 535 judges that the second condition is satisfied. Post-processing is performed after a response is made to the inspection result. Post-processing is predetermined processing. For example, post-processing is processing performed to notify the administrator of the fact that response information has been received, to delete of the previous improper inspection result, and to add a flag to the previous improper inspection result. Note that this flag indicates that a response has been made.

For example, the post-processing unit 536 acquires the e-mail address of the supervisor paired with the applicant identifier corresponding to the response information, and/or the e-mail address of the person in the accounting department, from the e-mail address storage unit 511, and transmit information indicating that response information has been received, to the e-mail address(es).

For example, the post-processing unit 536 deletes the inspection result corresponding to the response information, from the storage unit 51.

For example, the post-processing unit 536 deletes the inspection result corresponding to the response information, from the storage unit 51.

The third judging unit 537 judges whether or not the response receiving unit 521 has received response information by the response deadline.

For example, the third judging unit 537 acquires the response deadline in the response deadline storage unit 512. Also, the third judging unit 537 acquires the starting date information corresponding to the improper inspection result. Starting date information is, for example, information regarding the date when contact processing was performed, or information regarding the date when the application for expense information was submitted. Next, using the starting date information and the response deadline, the third judging unit 537 judges whether or not response information regarding the inspection result has been received by the last date of the response deadline.

If the third judging unit 537 determines that no response has been received by the response deadline, the no-response processing unit 538 performs predetermined no-response processing. No-response processing is processing for the case of the absence of a response. For example, no-response processing is performed to provide a reminder to the applicant for a response, to delete the expense information corresponding to improper inspection result, to provide a notification to the applicant, indicating that expense application will not be accepted, or to accumulate information indicating that the response input deadline has passed, in association with the inspection result.

The second storage unit 61 included in each administrator terminal 6 stores various kinds of information. Examples of various kinds of information include an administrator identifier.

The second acceptance unit 62 accepts various kinds of instructions and information. Examples of various kinds of instructions and information include an instruction to output an inspection result.

The second processing unit 63 performs various kinds of processing. Examples of various kinds of processing include processing that is performed to convert instructions and information accepted by the second acceptance unit 62 into instructions and information in the data structure to be transmitted. Examples of various kinds of information include processing that is performed to convert information received by the second receiving unit 65 into information in the data structure to be output.

The second transmitting unit 64 transmits various kinds of instructions and information. Examples of the various kinds of instructions and information include an instruction to output an inspection result.

The second receiving unit 65 receives various kinds of information. Examples of various kinds of information include the URI of a web page on which the inspection result is present, the inspection result, and response information.

The second output unit 66 outputs various kinds of information. Examples of various kinds of information include an inspection result, an image inspection result, and response information.

The second storage unit 61 included in each administrator terminal 6 stores various kinds of information. Examples of various kinds of information include an administrator identifier.

The second acceptance unit 62 accepts various kinds of instructions and information. Examples of the various kinds of instructions and information include an instruction to output an inspection result and an instruction to output response information. Such an output instruction includes a URI, for example.

The second processing unit 63 performs various kinds of processing. Examples of various kinds of processing include processing that is performed to convert instructions and information accepted by the second acceptance unit 62 into instructions and information in the data structure to be transmitted. Examples of various kinds of information include processing that is performed to convert information received by the second receiving unit 65 into information in the data structure to be output.

The second transmitting unit 64 transmits various kinds of instructions and information. Examples of the various kinds of instructions and information include an instruction to output an inspection result and an instruction to output response information.

The second receiving unit 65 receives various kinds of information. Examples of various kinds of information include an inspection result, an image inspection result, and response information.

The second output unit 66 outputs various kinds of information. Examples of various kinds of information include an inspection result, an image inspection result, and response information.

It is preferable that the storage unit 51, the e-mail address storage unit 511, the response deadline storage unit 512, and the second storage unit 61 are realized using a non-volatile recording medium, but they may be realized using a volatile recording medium.

There is no limitation on the process in which information is stored in the storage unit 51 or the like. For example, information may be stored in the storage unit 51 or the like via a recording medium, or information transmitted via a communication line or the like may be stored in the storage unit 51 or the like, or information input via an input device may be stored in the storage unit 51 or the like.

The acceptance unit 52, the expense acceptance unit 121, the response receiving unit 521, and the second receiving unit 65 typically are realized using a wireless or wired communication means, but may be realized using a broadcast receiving means.

The processing unit 53, the inspection result acquisition unit 531, the first judging unit 532, the contact processing unit 533, the response accumulation unit 534, the second judging unit 535, the post-processing unit 536, the third judging unit 537, the no-response processing unit 538, and the second processing unit 63 typically are realized using an MPU, a memory, and so on. The processing procedures performed by the processing unit 53 or the like typically are realized using software, and the software is recorded on a recording medium such as a ROM. However, such processing procedures may be realized using hardware (a dedicated circuit).

The contact processing unit 533, the output unit 54 and the second transmitting unit 64 typically are realized using a wireless or wired communication means, but may be realized using a broadcast receiving means.

The second acceptance unit 62 can be realized using a device driver for the input means such as a touch panel or a keyboard, or control software or the like for controlling the menu screen.

The second output unit 66 may be regarded as including or not including an output device such as a display or a speaker. The second output unit 66 can be realized using the driver software of the output device, the driver software of the output device and the output device, or the like.

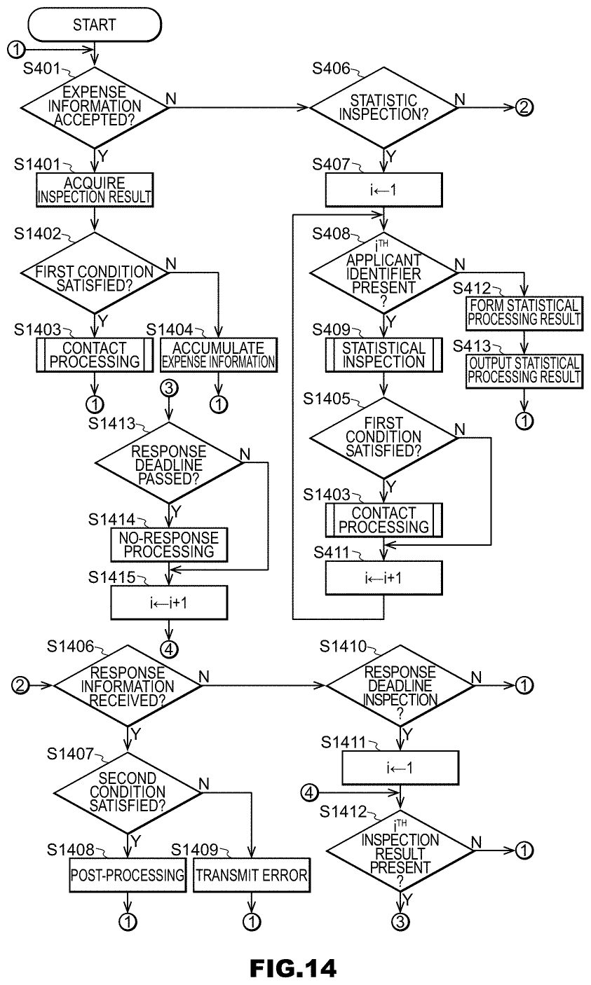

Next, examples of operations of the expense management device 5 will be described with reference to the flowchart in FIG. 14. In the flowchart in FIG. 14, the descriptions of the same steps as in the flowchart in FIG. 4 will be omitted.

(Step S1401) The inspection result acquisition unit 531 acquires an inspection result corresponding to the one or more pieces of expense information accepted in step S401. Here, it is preferable that the inspection result acquisition unit 531 accumulates the acquired inspection result in association with the expense information.

(Step S1402) The first judging unit 532 acquires the first condition from the storage unit 51. Next, the first judging unit 532 judges whether or not the inspection result acquired in step S1401 satisfies the first condition. If the first condition is satisfied, processing proceeds to step S1403, and if the first condition is not satisfied, processing proceeds to step S1404.

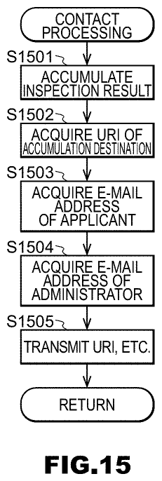

(Step S1403) The contact processing unit 533 performs contact processing. Processing returns to step S1401. An example of contact processing will be described with reference to the flowchart in FIG. 15.

(Step S1404) The processing unit 53 accumulates the accepted expense information in the expense information storage unit 111. Processing returns to step S1401.

(Step S1405) The first judging unit 532 acquires the first condition from the storage unit 51. Next, the first judging unit 532 judges whether or not the statistical processing result acquired in step S409 satisfies the first condition. If the first condition is satisfied, processing proceeds to step S1403, and if the first condition is not satisfied, processing proceeds to step S411. If processing proceeds to step S1403 through this route, processing proceeds to step S411 after step S1403.

Examples of the statistical processing result include store frequency information and entertainment frequency information. The first condition is, for example, “store frequency information>=threshold value”, “store frequency information>threshold value”, “entertainment frequency information>=threshold value”, or “entertainment frequency information>threshold value”. Examples of such processing include the processing described in “(12) Inspection using Statistical Processing Result” in the first embodiment.

(Step S1406) The response receiving unit 521 judges whether or not response information has been received from the applicant terminal 2 in association with the applicant identifier and the inspection result identifier. If response information has been received, processing proceeds to step S1407, and if response information has not been received, processing proceeds to step S1410.

(Step S1407) The second judging unit 535 reads out the second condition from the storage unit 51. Next, the second judging unit 535 determines whether or not the response information received in step S1406 satisfies the second condition. If the second condition is satisfied, processing proceeds to step S1408, and if the second condition is not satisfied, processing proceeds to step S1409.

(Step S1408) The post-processing unit 536 performs post-processing. Processing returns to step S1401.

(Step S1409) The output unit 54 transmits an error message to the applicant terminal 2 from which the response information has been transmitted. Processing returns to step S1401. Note that the error message is stored in the storage unit 51, for example.

(Step S1410) The processing unit 53 judges whether or not it is the time to perform a response deadline inspection. If it is the time, processing proceeds to step S1411, and if it is not the time, processing returns to step S1401. Note that the processing unit 53 regularly judges that it is the time, for example. The processing unit 53 judges that it is the time at a predetermined time, for example. The time to perform the inspection is not limited.

(Step S1411) The third judging unit 537 substitutes 1 for the counter i.

(Step S1412) The third judging unit 537 judges whether or not the i^{th} inspection result of the inspection target at the response deadline is present. If the i^{th} inspection result is present, processing proceeds to step S1413, and if the i^{th} inspection result is not present, processing returns to step S1401.

(Step S1413) The third judging unit 537 judges whether or not response information corresponding to the i^{th} inspection result is absent in the storage unit 51, and whether or not the response deadline corresponding to the i^{th} inspection result has passed. If such a condition is satisfied, processing proceeds to step

S1414, and if not satisfied, processing proceeds to step S1415.

(Step S1414) The no-response processing unit 538 performs no-response processing.

(Step S1415) The third judging unit 537 increments the counter i by one. Processing returns to step S1412.

Note that, in the flowchart in FIG. 14, processing ends when the power is turned off or an interruption occurs to end the processing.

Next, an example of the contact processing in step S1403 will be described with reference to the flowchart in FIG. 15.

(Step S1501) The contact processing unit 533 accumulates one or more inspection results acquired by the inspection result acquisition unit 531, in association with the applicant identifier corresponding to one or more pieces of expense information accepted by the expense acceptance unit 121.

(Step S1502) The contact processing unit 533 acquires the URL of the web page for which inspection results have been accumulated in step S1501.

(Step S1503) The contact processing unit 533 acquires the e-mail address of the applicant paired with the applicant identifier corresponding to the expense information accepted by the expense acceptance unit 121, from the personal information storage unit 1121 that stores one or more pieces of personal information each including an applicant identifier and an e-mail address.

(Step S1504) The contact processing unit 533 acquires the e-mail address of each of the one or more administrators from the e-mail address storage unit 511.

(Step S1505) The contact processing unit 533 transmits information that includes the URL of the web page to the e-mail address of the applicant acquired in step S1503. Also, the contact processing unit 533 transmits information that includes the URL of the web page to the e-mail address of each of one or more administrators acquired in step S1504. Processing returns to higher-level processing. Note that the e-mail to be transmitted to the applicant and the e-mail transmitted to the administrators may be different or the same.

Next, operations of each applicant terminal 2 will be described. The applicant terminal 2 receives an e-mail that includes the URI of the web page where improper inspection results are stored, in response to an instruction from the applicant. The applicant terminal 2 outputs the e-mail. Also, the applicant terminal 2 receives a web page where improper inspection results are stored, in response to an instruction indicating an URI, from the applicant.

The applicant reads the improper inspection results and inputs response information corresponding to the inspection results into the applicant terminal 2. Accordingly, the applicant terminal 2 receives response information. Thereafter, the applicant terminal 2 transmits the inspection result identifier, the applicant identifier, and the response information to the expense management device 5. Also, the applicant terminal 2 receives a result corresponding to the transmission of the response information, and outputs the result.

Next, operations of each administrator terminal 6 will be described. The administrator terminal 6 receives an e-mail that includes the URI of the web page where improper inspection results are stored, in response to an instruction from the administrator. The administrator terminal 6 outputs the e-mail. If the administrator provides an instruction indicating the URI, the administrator terminal 6 receives and outputs the web page where improper inspection results are stored.

The administrator terminal 6 receives and outputs the response information input by the applicant. Thereafter, the administrator checks the response information thus output. The administrator input the result of checking the response information, in association with the response information. The administrator terminals 6 receives the result of the check, and transmits the result to the expense management device 5. Note that the result of the check, through which the administrator reads the response information input by the applicant, may be, for example, “eligibility confirmed” indicating that the expense application was qualified, “application rejected” indicating that the expense application was not approved, or the like.

Also, the administrator terminal 6 receives and outputs an inspection result indicating that no response has been received by the deadline, for example. The administrator checks the inspection result. As a result of the check, the administrator may remind the applicant to input response information.

Hereinafter, examples of specific operations of the expense management device 5 according to the present embodiment will be described.

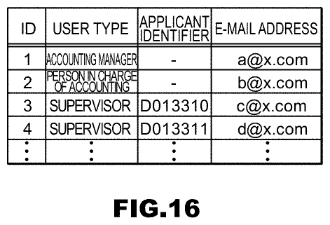

Now, the e-mail address storage unit 511 of the expense management device 5 stores the address management table shown in FIG. 16. The address management table is a table for managing e-mail addresses of the administrators that are to be notified of improper inspection results. The address management table stores one or more records each including “ID”, “user type”, “applicant identifier”, and “e-mail address”. “ID” is information that identifies a record. “User type” is information that identifies the type of the administrator.

In such a situation, it is assumed that the acceptance unit 52 of the expense management device 5 has accepted many pieces of expense information for April 2020 in association with the applicant identifier “D013310”.

Next, the inspection result acquisition unit 531 acquires an inspection result for each piece of expense information thus received. Note that the inspection result acquisition unit 531 may perform inspection processing by itself to acquire inspection results, or transmit each piece of expense information to the expense inspection device 1 and receive inspection results from the expense inspection device 1.

Next, it is assumed that the first judging unit 532 determines ten inspection results that each include information indicating “improper”, from among the inspection results corresponding to the pieces of expense information.

Next, using the ten inspection results that include information indicating “improper”, the contact processing unit 533 forms an improper inspection result group of which the applicant and the administrators are to be notified. Note that the improper inspection result group is a web page, for example.

Next, the contact processing unit 533 accumulates the improper inspection result group in the storage unit 51 in association with the applicant identifier “D013310”. Note that the improper inspection results that constitute the improper inspection result group are, here, “expense information identifier”, “status”, “applicant identifier”, “applicant name”, “position”, “report name”, “expense type”, “amount of money applied for”, and “confirmation details”. “Status” is the state of response information or the state of an inspection result. “Applicant name” is the name of the applicant acquired from the personal information storage unit 1121 using the applicant identifier as a key. “Position” is the name of the position of the applicant acquired from the personal information storage unit 1121 using the applicant identifier as a key. It is assumed that “report name” is information included in expense information, and is information input by the applicant when submitting the application. “Expense type” is an expense type identifier or a subject. “Amount of money applied for” is information regarding amount of money, included in expense information. “Confirmation details” is an inspection detail identifier.

Next, the contact processing unit 533 acquires a URL that is used to access the improper inspection result group. Note that the URL is, for example, “http://x.jp/improperinspectionresults/D013310”.

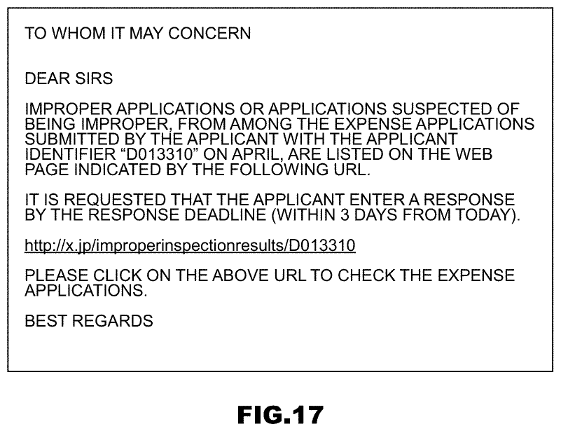

Next, the contact processing unit 533 forms an e-mail that includes the acquired URL. An example of such an e-mail is shown in FIG. 17.

Next, the contact processing unit 533 acquires the e-mail address “do13310@x.com” of the applicant paired with the applicant identifier “D013310” from the personal information storage unit 1121 that stores one or more pieces of personal information.

Next, the contact processing unit 533 acquires the e-mail addresses of “a@x.com” and “b@x.com” of the administrators, which are independent of the applicant identifier, from the address management table. Next, the contact processing unit 533 acquires the e-mail address “c@x.com” of the supervisor paired with the applicant identifier “D013310”, from the address management table.

Next, the contact processing unit 533 transmits the e-mail that includes the URL of the web page (FIG. 17) to the e-mail address “do13310@x.com” of the applicant.

Also, the contact processing unit 533 transmits the e-mail that includes the URL of the web page (FIG. 17) to three administrators “a@x.com”, “b@x.com”, and “c@x.com”.

Next, it is assumed that the applicant reads the e-mail and clicks on the URL “http://x.jp/improperinspectionresults/D013310”.

As a result, a web page showing the improper inspection result group is output to the applicant terminal 2. It is assumed that the applicant thereafter reads information regarding the inspection results corresponding to the 10 improper applications, and inputs response information for some of the inspection results. Accordingly, the applicant terminal 2 receives response information, and transmits the response information to the expense management device 5 together with the inspection result identifiers.

Next, the expense management device 5 receives the inspection result identifiers and the response information, and accumulates the received response information in the page corresponding to the URL “http://x.jp/improperinspectionresults/D013310” in association with the inspection results identified by the inspection result identifiers. Also, the processing unit 53 accumulates “reason input complete” indicating the status of the response in association with the received response information.

Also, the administrator reads the response information input by the applicant and judges whether or not the response is reasonable. Thereafter, the administrator inputs “eligibility confirmed” or “application rejected” to the administrator terminal 6 in association with the response information. The administrator terminal 6 receives such an input from the administrator and transmits the input to the expense management device 5.

Next, the expense management device 5 receives the input, and accumulates the input in association with the response information. Such an input (“eligibility confirmed” or “application rejected”) is the status of the response, and with which the previous status “reason input complete” is overwritten.

The processing unit 53 of the expense management device 5, upon judging that it is the time to inspect the response deadline, judges whether or not the response deadline has passed, and whether or not an inspection result without a response is present. It is assumed that the third judging unit 537 judges that the response deadline has passed regarding one inspection result. Next, the no-response processing unit 538 performs no-response processing. Here, no-response processing is defined as processing performed to accumulate “reason input deadline passed” in association with the inspection result. “Reason input deadline passed” is information indicating that the deadline for inputting a response has passed. Note that “reason input deadline passed” is the status of the response, and with which the previous status “reason not input” is overwritten.

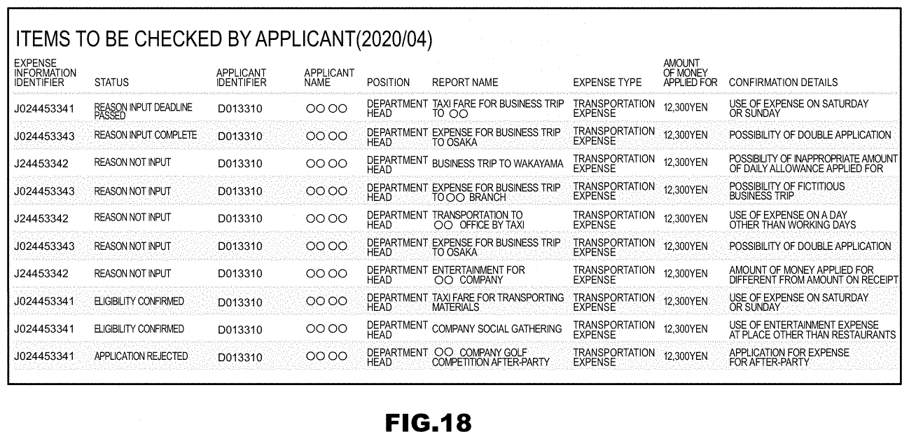

Based on the above situation, it is assumed that the applicant has input an instruction to output inspection results including the URL “http://x.jp/improperinspectionresults/D013310”, to the applicant terminal 2. As a result, a web page showing the improper inspection result group, which is shown in FIG. 18, is output to the applicant terminal 2. As a result, the applicant can grasp the status of the expense applications submitted by themselves.

It is assumed that the administrator also input an instruction to output an inspection result that includes the URL “http://x.jp/improperinspectionresults/D013310”. As a result, the web page showing the improper inspection result group, which is shown in FIG. 18, is output to the applicant terminal 6 as well. As a result, the administrator can provide guidance to the applicant regarding an expense application.

As described above, according to the present embodiment, it is possible to inform the applicant or the administrator of the inspection results of an expense application.

Also, according to the present embodiment, it is possible to inform the applicant or the administrator of the inspection results of an expense application only when expense information is improper.

Also, according to the present embodiment, it is possible to receive and manage a response regarding an expense application.

Also, according to the present embodiment, it is possible to perform appropriate processing corresponding to the received response.

Furthermore, according to the present embodiment, it is possible to perform appropriate processing when a response is not received by the deadline.

The software that realizes the expense management device 5 in the present embodiment is the program described below. That is to say, the program is a program that enables a computer to function as: an expense acceptance unit that accepts expense information that specifies details of an application for an expense; an inspection result acquisition unit that acquires an inspection result regarding an inspection of improperness regarding the expense information accepted by the expense acceptance unit; a first judging unit that judges whether or not the inspection result acquired by the inspection result acquisition unit satisfies a predetermined first condition; and a contact processing unit that performs contact processing to provide the inspection result to an applicant of the expense information when the judging unit judges that the first condition is satisfied.

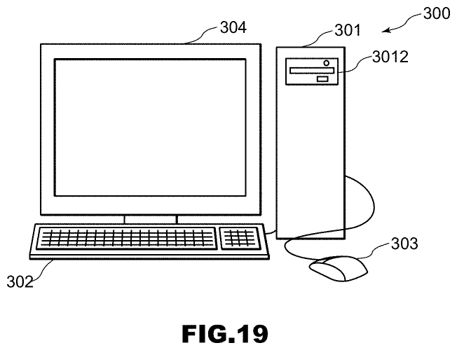

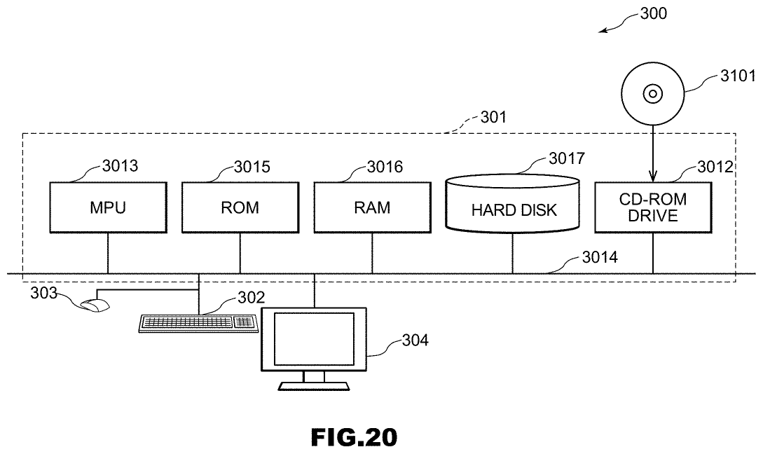

FIG. 19 shows the external appearance of a computer that executes the program described herein to realize the expense inspection device 1 and so on according to the various embodiments described above. The above-described embodiment can be realized using a computer hardware and a computer program that is executed thereon. FIG. 19 is a schematic diagram showing this computer system 300, and FIG. 20 is a block diagram for the system 300.

In FIG. 19, the computer system 300 includes a computer 301 that includes a CD-ROM drive, a keyboard 302, a mouse 303, and a monitor 304.

In FIG. 20, the computer 301 includes, in addition to the CD-ROM drive 3012, an MPU 3013, a bus 3014 that is connected to the CD-ROM drive 3012 and so on, a ROM 3015 for storing programs such as a boot-up program, a RAM 3016 that is connected to the MPU 3013 and is used to temporarily store application program instructions and provide a temporary storage space, and a hard disk 3017 for storing application programs, system programs, and data. Here, although not shown in the drawings, the computer 301 may further include a network card that provides connection to a LAN.

The program that enables the computer system 300 to perform the functions of the expense inspection device 1 and so on according to the above-described embodiments may be stored in the CD-ROM 3101, inserted into the CD-ROM drive 3012, and furthermore transferred to the hard disk 3017. Alternatively, the program may be transmitted to the computer 301 via a network (not shown) and stored on the hard disk 3017. The program is loaded into the RAM 3016 when the program is to be executed. The program may be directly loaded from the CD-ROM 3101 or the network.

The program does not necessarily have to include an operating system (OS), a third-party program, or the like that enables the computer 301 to perform the functions of the expense inspection device 1 and so on according to the above-described embodiments. The program need only contain the part of the instruction that calls an appropriate function (module) in a controlled manner to achieve a desired result. How the computer system 300 works is well known and the detailed descriptions thereof will be omitted.

In the above-described program, the step of transmitting information and the step of receiving information do not include processing performed by hardware, for example, processing performed by a modem or interface card in the step of transmitting (processing that can only be performed by hardware).

There may be a single or multiple computers executing the above-described program. That is to say, centralized processing or distributed processing may be performed. That is to say, the expense inspection device 1 may be a stand-alone device, or be constituted by two or more devices.

In addition, as a matter of course, in each of the above-described embodiments, two or more communication means that are present in one device may be physically realized using one medium.

In each of the above-described embodiments, each kind of processing may be realized as centralized processing that is performed by a single device, or distributed processing that is performed by multiple devices.

The present invention is not limited to the above-described embodiments, and various changes are possible, and such variations are also included within the scope of the present invention, as a matter of course.

### INDUSTRIAL APPLICABILITY

As described above, an expense inspection device according to the present invention achieves the effect of appropriately performing an inspection of improper expense applications, and is useful as an expense inspection device or the like.

1-12. (canceled)

13. An expense management device comprising:
an expense acceptance unit that accepts expense information that specifies details of an application for an expense;
an inspection result acquisition unit that acquires an inspection result that is a result of an inspection of improperness regarding the expense information accepted by the expense acceptance unit;
a first judging unit that judges whether or not the inspection result acquired by the inspection result acquisition unit is an inspection result related to improperness;
a contact processing unit that performs contact processing to provide the inspection result to an applicant of the expense information when the first judging unit judges that the inspection result is an inspection result related to improperness;
a response receiving unit that receives response information regarding a response to the inspection result from an applicant terminal, in association with an applicant identifier;
a second judging unit that judges whether or not the response information satisfies a predetermined second condition; and
a post-processing unit that, when the second judging unit judges that the second condition is satisfied, performs post-processing after a response is made to the inspection result,
wherein the second condition is that the response information includes a required item, the number of characters included in the response information is no less than a threshold value, or a follow-up inspection result is valid, and
when the second condition is that the follow-up inspection result is valid, the inspection result acquisition unit acquires an inspection result related to the result of the inspection of improperness regarding the expense information included in the response information.

14. An expense management device comprising:
an expense acceptance unit that accepts expense information that specifies details of an application for an expense;
an inspection result acquisition unit that acquires an inspection result that is a result of an inspection of improperness regarding the expense information accepted by the expense acceptance unit;
a first judging unit that judges whether or not the inspection result acquired by the inspection result acquisition unit is an inspection result related to improperness;
a contact processing unit that performs contact processing to provide the inspection result to an applicant of the expense information when the first judging unit judges that the inspection result is an inspection result related to improperness;
a response receiving unit that receives response information regarding a response to the inspection result from an applicant terminal, in association with an applicant identifier;
a response deadline storage unit that stores a response deadline;
a third judging unit that judges whether or not the response receiving unit has received the response information by the response deadline; and
a no-response processing unit that performs predetermined no-response processing for the case of the absence of a response when the third judging unit judges that the response information has not been received by the response deadline.

15. The expense management device according to claim 1,
wherein the contact processing unit performs accumulation processing to accumulate the inspection result in association with an applicant identifier corresponding to the expense information accepted by the expense acceptance unit.

16. The expense management device according to claim 1,
wherein the contact processing unit performs first transmission processing to acquire a URI that is used to access the inspection result, acquire the applicant identifier corresponding to the expense information accepted by the expense acceptance unit, acquire an e-mail address that is paired with the applicant identifier, from a personal information storage unit that stores one or more pieces of personal information that each include an applicant identifier and an e-mail address, and transmit the URI, using the e-mail address.

17. The expense management device according to claim 1,
an e-mail address storage unit that stores an e-mail address of a person in charge of accounting,
wherein the contact processing unit performs second transmission processing to acquire a URI that is used to access the inspection result, and transmit the URI, using the e-mail address of the person in charge of accounting.

18. The expense management device according to claim 1,
wherein the contact processing unit performs third transmission processing to acquire the applicant identifier corresponding to the expense information accepted by the expense acceptance unit, acquire an e-mail address that is paired with the applicant identifier, from a personal information storage unit that stores one or more pieces of personal information that each include an applicant identifier and an e-mail address, and transmit the inspection result, using the e-mail address.

19. The expense management device according to claim 1, further comprising:
an e-mail address storage unit that stores an e-mail address of a person in charge of accounting,
wherein the contact processing unit performs fourth transmission processing to transmit the inspection result, using the e-mail address of the person in charge of accounting.

20. The expense management device according to claim 1, further comprising:
a response accumulation unit that accumulates the response information received by the response receiving unit, in association with the inspection result.

21. The expense management device according to claim 1,
wherein the inspection result acquisition unit acquires, from a storage unit that stores one or more pieces of entry/exit information that are associated with an applicant identifier and that each specify date and time when an applicant identified by the applicant identifier entered/exited a place of work thereof, a piece of entry/exit information that is associated with the applicant identifier associated with the expense information and that corresponds to date and time specified by usage date information that is included in the expense information, and performs an inspection of improperness regarding the expense information accepted by the expense acceptance unit, using the piece of entry/exit information, to acquire an inspection result.

22. The expense management device according to claim 1,
wherein the inspection result acquisition unit acquires, from a storage unit that stores two or more pieces of applicant information that are associated with an applicant identifier, and includes attendance information that includes one or more sets each consisting of one or more pieces of working day information that each specify a day on which an applicant corresponding thereto worked and working time information that specifies a time zone for which the applicant worked, or one or more pieces of entry/exit information that each specify date and time at which the applicant entered/exited a place of work thereof, a piece of working time information that is associated with the applicant identifier associated with the expense information and that is paired with working day information that is the same as the usage date information included in the expense information, or a piece of entry/exit information that is associated with the applicant identifier associated with the expense information and that corresponds to a day that is the same as a day indicated by the usage date information included in the expense information, and judges whether or not an overnight stay at an accommodation facility is permitted, using the working time information or the work end time and overtime time work time information that indicates overtime work time from which an overnight stay is permitted, to acquire an inspection result.

23. The expense management device according to claim 2,
wherein the contact processing unit performs accumulation processing to accumulate the inspection result in association with an applicant identifier corresponding to the expense information accepted by the expense acceptance unit.

24. The expense management device according to claim 2,
wherein the contact processing unit performs first transmission processing to acquire a URI that is used to access the inspection result, acquire the applicant identifier corresponding to the expense information accepted by the expense acceptance unit, acquire an e-mail address that is paired with the applicant identifier, from a personal information storage unit that stores one or more pieces of personal information that each include an applicant identifier and an e-mail address, and transmit the URI, using the e-mail address.

25. The expense management device according to claim 2,
an e-mail address storage unit that stores an e-mail address of a person in charge of accounting,
wherein the contact processing unit performs second transmission processing to acquire a URI that is used to access the inspection result, and transmit the URI, using the e-mail address of the person in charge of accounting.

26. The expense management device according to claim 2,
wherein the contact processing unit performs third transmission processing to acquire the applicant identifier corresponding to the expense information accepted by the expense acceptance unit, acquire an e-mail address that is paired with the applicant identifier, from a personal information storage unit that stores one or more pieces of personal information that each include an applicant identifier and an e-mail address, and transmit the inspection result, using the e-mail address.

27. The expense management device according to claim 2, further comprising:
an e-mail address storage unit that stores an e-mail address of a person in charge of accounting,
wherein the contact processing unit performs fourth transmission processing to transmit the inspection result, using the e-mail address of the person in charge of accounting.

28. The expense management device according to claim 2, further comprising:
a response accumulation unit that accumulates the response information received by the response receiving unit, in association with the inspection result.

29. The expense management device according to claim 2,
wherein the inspection result acquisition unit acquires, from a storage unit that stores one or more pieces of entry/exit information that are associated with an applicant identifier and that each specify date and time when an applicant identified by the applicant identifier entered/exited a place of work thereof, a piece of entry/exit information that is associated with the applicant identifier associated with the expense information and that corresponds to date and time specified by usage date information that is included in the expense information, and performs an inspection of improperness regarding the expense information accepted by the expense acceptance unit, using the piece of entry/exit information, to acquire an inspection result.

30. The expense management device according to claim 2,
wherein the inspection result acquisition unit acquires, from a storage unit that stores two or more pieces of applicant information that are associated with an applicant identifier, and includes attendance information that includes one or more sets each consisting of one or more pieces of working day information that each specify a day on which an applicant corresponding thereto worked and working time information that specifies a time zone for which the applicant worked, or one or more pieces of entry/exit information that each specify date and time at which the applicant entered/exited a place of work thereof, a piece of working time information that is associated with the applicant identifier associated with the expense information and that is paired with working day information that is the same as the usage date information included in the expense information, or a piece of entry/exit information that is associated with the applicant identifier associated with the expense information and that corresponds to a day that is the same as a day indicated by the usage date information included in the expense information, and judges whether or not an overnight stay at an accommodation facility is permitted, using the working time information or the work end time and overtime time work time information that indicates overtime work time from which an overnight stay is permitted, to acquire an inspection result.

31. An information processing method that is realized using an expense acceptance unit, an inspection result acquisition unit, a first judging unit, a contact processing unit, a response receiving unit, a second judging unit, and a post-processing unit, the information processing method comprising:
an expense acceptance step in which the expense acceptance unit accepts expense information that specifies details of an application for an expense;
an inspection result acquisition step in which the inspection result acquisition unit acquires an inspection result that is a result of an inspection of improperness regarding the expense information accepted in the expense acceptance step;
a first judging step in which the first judging unit judges whether or not the inspection result acquired in the inspection result acquisition step is an inspection result related to improperness;
a contact processing step in which the contact processing unit performs contact processing to provide the inspection result to an applicant of the expense information when the inspection result is judged as an inspection result related to improperness in the first judging step;
a response receiving step in which the response receiving unit receives response information regarding a response to the inspection result from an applicant terminal, in association with an applicant identifier;
a second judging step in which the second judging unit judges whether or not the response information satisfies a predetermined second condition; and
a post-processing step in which, when the second judging unit judges that the second condition is satisfied, the post-processing unit performs post-processing after a response is made to the inspection result,
wherein the second condition is that the response information includes a required item, the number of characters included in the response information is no less than a threshold value, or a follow-up inspection result is valid, and
when the second condition is that the follow-up inspection result is valid, the inspection result acquisition unit acquires an inspection result related to the result of the inspection of improperness regarding the expense information included in the response information.

32. An information processing method that is realized using a response deadline storage unit that stores a response deadline, an expense acceptance unit, an inspection result acquisition unit, a first judging unit, a contact processing unit, a response receiving unit, a third judging unit, and a no-response processing unit, the information processing method comprising:
an expense acceptance step in which the expense acceptance unit accepts expense information that specifies details of an application for an expense;
an inspection result acquisition step in which the inspection result acquisition unit acquires an inspection result that is a result of an inspection of improperness regarding the expense information accepted by the expense acceptance unit;
a first judging step in which the first judging unit judges whether or not the inspection result acquired in the inspection result acquisition step is an inspection result related to improperness;
a contact processing step in which the contact processing unit performs contact processing to provide the inspection result to an applicant of the expense information when the inspection result is judged as an inspection result related to improperness in the first judging step;
a response receiving step in which the response receiving unit receives response information regarding a response to the inspection result from an applicant terminal, in association with an applicant identifier;
a third judging step in which the third judging unit judges whether or not the response receiving unit has received the response information by the response deadline; and
a no-response processing step in which the no-response processing unit performs predetermined no-response processing for the case of the absence of a response when the third judging unit judges that the response information has not been received by the response deadline.
